(19) United States
(12) Patent Application Publication
(10) Pub. No.: US 2006/0127777 A1
(43) Pub. Date: Jun. 15, 2006

(54) Battery

(76) Inventors: Masayuki Ihara, Fukushima (JP); Atsumichi Kawashima, Fukushima (JP); Tadahiko Kubota, Kanagawa (JP)

Correspondence Address: William E. Vaughan;Bell, Boyd & Lloyd LLC, P.O. Box 1135, Chicago, IL, 60690, US

(21) Appl. No.: 11/301,477

(22) Filed: Dec. 12, 2005

(30) Foreign Application Priority Data
Dec. 14, 2004 (JP) P2004-361400

(51) Int. Cl. H01M 10/40; H01M 4/58

(52) U.S. Cl. 429/326; 429/220; 429/339; 429/341; 429/218.1

(57) ABSTRACT

A battery capable of improving cycle characteristics is provided. A spirally wound electrode body in which a cathode and an anode are layered with a separator in between and wound is included inside a battery can. An electrolytic solution is impregnated in the separator. For the solvent, a mixed solvent of a cyclic ester derivative having halogen atom and a chain compound having halogen atom is used. Thereby, decomposition reaction of the solvent in the anode is inhibited, and cycle characteristics are improved.

### CROSS REFERENCES TO RELATED APPLICATIONS

The present application claims priority to Japanese Patent Application JP 2004-361400 filed in the Japanese Patent Office on Dec. 14, 2004, the entire contents of which is being incorporated herein by reference.

### BACKGROUND

The present invention relates to a battery including a cathode, an anode, and an electrolyte, particularly to a battery including a cathode, an anode, and an electrolyte and using lithium (Li) or the like as an electrolytic reactant.

In recent years, many portable electronic devices such as a combination camera (video tape recorder), a digital still camera, a mobile phone, a personal digital assistance, and a notebook personal computer have been introduced, and down sizing and weight saving thereof have been made. Accordingly, research and development for improving the energy density of batteries, particularly the secondary batteries as a portable power source for such electronic devices has been actively promoted. Specially, the lithium ion secondary battery in which a carbon material is used for the anode, a complex material of lithium and a transition metal is used for the cathode, and ester carbonate is used for an electrolytic solution provides a higher energy density compared to traditional lead batteries and nickel cadmium batteries, and therefore the lithium ion secondary battery is in practical use widely.

Further, in recent years, as performance of portable electronic devices has been improved, further improvement of the capacity has been demanded. It has been considered that as an anode active material, tin (Sn), silicon (Si) or the like is used instead of carbon materials. The theoretical capacity of tin is 994 mAh/g, and the theoretical capacity of silicon is 4199 mAh/g, which are significantly large compared to the theoretical capacity of graphite, 372 mAh/g, and therefore capacity improvement can be expected therewith. It is reported that in particular, in the anode in which a thin film of tin or silicon is formed on the current collector, the anode active material is not pulverized by insertion and extraction of lithium, and a relatively high discharge capacity can be retained (for example, refer to International Publication No. WO01/031724).

However, a tin alloy or a silicon alloy inserting lithium has a high activity. Therefore, there has been a disadvantage that, for example, when cyclic ester carbonate as the high dielectric constant solvent and chain ester carbonate as the low viscosity solvent are used for the electrolyte, in particular chain ester is decomposed, and further lithium is inactivated. Therefore, when charge and discharge are repeated, charge and discharge efficiency is lowered, and sufficient cycle characteristics are not able to be obtained.

### SUMMARY

In view of the foregoing, in the present invention, it is desirable to provide a battery capable of improving cycle characteristics.

According to an embodiment of the present invention, there is provided a battery including a cathode, an anode, and an electrolyte, in which the anode contains an anode material capable of inserting and extracting an electrode reactant and containing at least one of metal elements and metalloid elements as an element, and the electrolyte contains a cyclic ester derivative having halogen atom and at least one of chain compounds expressed in Chemical formula 1 to Chemical formula 8.

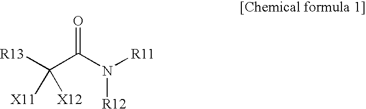

In the formula, R11 and R12 represent a hydrogen group, an alkyl group with carbon number of 1 to 15 or a group obtained by substituting at least part of hydrogen thereof with halogen, an alkoxyl group with carbon number of 2 to 15 or a group obtained by substituting at least part of hydrogen thereof with halogen, an aryl group with carbon number of 6 to 20 or a group obtained by substituting at least part of hydrogen thereof with halogen, a group obtained by substituting part of hydrogen of an alkyl group with carbon number of 7 to 20 with an aryl group or a group obtained by substituting at least part of hydrogen thereof with halogen, or an acyl group with carbon number of 1 to 15. R13 represents a hydrogen group, a halogen group, an alkyl group with carbon number of 1 to 20 or a group obtained by substituting at least part of hydrogen thereof with a substituent, an alkoxyl group with carbon number of 1 to 20 or a group obtained by substituting at least part of hydrogen thereof with a substituent, a group obtained by substituting at least part of hydrogen of an aryl group with carbon number of 7 to 20 with an alkoxyl group or a group obtained by substituting at least part of hydrogen thereof with other substituent, an acyl group with carbon number of 1 to 20 or a group obtained by substituting at least part of hydrogen thereof with a substituent, an aryl group with carbon number of 6 to 20 or a group obtained by substituting at least part of hydrogen thereof with halogen, or a heterocyclic group with carbon number of 4 to 20 or a group obtained by substituting at least part of hydrogen thereof with halogen. X11 and X12 represent a halogen group or a perfluoro alkyl group with carbon number of 1 to 10.

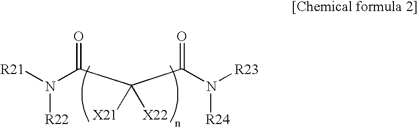

In the formula, R21, R22, R23, and R24 represent a hydrogen group, an alkyl group with carbon number of 1 to 15 or a group obtained by substituting at least part of hydrogen thereof with halogen, an alkoxyl group with carbon number of 2 to 15 or a group obtained by substituting at least part of hydrogen thereof with halogen, an aryl group with carbon number of 6 to 20 or a group obtained by substituting at least part of hydrogen thereof with halogen, a group obtained by substituting part of hydrogen of an alkyl group with carbon number of 7 to 20 with an aryl group or a group obtained by substituting at least part of hydrogen thereof with halogen, or an acyl group with carbon number of 1 to 15. X21 and X22 represent a halogen group or a perfluoro alkyl group with carbon number of 1 to 10. n represents an integer number from 1 to 4.

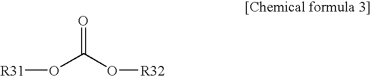

In the formula, R31 and R32 represent an alkyl group with carbon number of 1 to 5 or a group obtained by substituting at least part of hydrogen thereof with halogen. At least one of R31 and R32 is a group having halogen.

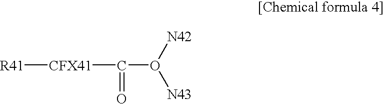

In the formula, R41 represents a hydrogen group, a fluorine group, a chlorine group, a bromine group, or an alkyl group with carbon number of 1 to 3 or a group obtained by substituting at least part of hydrogen thereof with halogen. X41 represents a hydrogen group, a fluorine group, a chlorine group, or a bromine group. R42 and R43 represent a methyl group or an ethyl group.

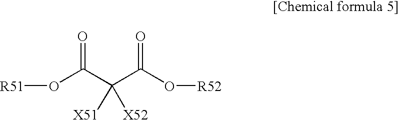

In the formula, R51 and R52 represent an alkyl group with carbon number of 1 to 3, an aryl group, or a group obtained by substituting at least part of hydrogen thereof with halogen. X51 and X52 represent a hydrogen group, a halogen group, or a trifluoromethyl group. At least one of X51 and X52 is a group having halogen.

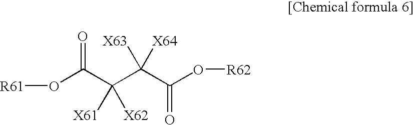

In the formula, R61 and R62 represent an alkyl group with carbon number of 1 to 3, an aryl group, or a group obtained by substituting at least part of hydrogen thereof with halogen. X61, X62, X63, and X64 represent a hydrogen group, a halogen group, or a trifluoromethyl group. At least one of X61 and X62 and at least one of X63 and X64 are a group having halogen.

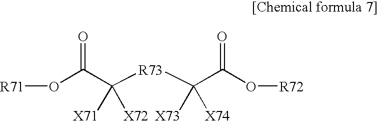

In the formula, R71 and R72 represent an alkyl group with carbon number of 1 to 3, an aryl group, or a group obtained by substituting at least part of hydrogen thereof with halogen. R73 represents oxygen, sulfur, SO, SO₂, N—X (where X represents a monovalent substituent), P-Z (where Z represents a monovalent substituent), a group having alicycle, aromatic ring or heterocycle, an alkylene group with carbon number of 1 to 4 or a group obtained by substituting at least part of hydrogen thereof with halogen or a trifluoromethyl group, or a group with carbon number of 1 to 4 having oxygen, sulfur, SO, SO₂, N—X (where X represents a monovalent substituent), or P-Z (where Z represents a monovalent substituent) between carbon atoms or a group obtained by substituting at least part of hydrogen thereof with halogen or a trifluoromethyl group. X71, X72, X73, and X74 represent a hydrogen group, a halogen group, or a trifluoromethyl group. At least one of X71 and X72 and at least one of X73 and X74 are a group having halogen.

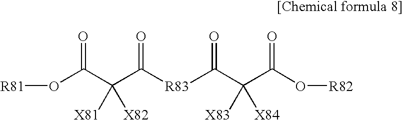

In the formula, R81 and R82 represent an alkyl group with carbon number of 1 to 3, an aryl group, or a group obtained by substituting at least part of hydrogen thereof with halogen. R83 represents oxygen, sulfur, SO, SO₂, N—X (where X represents a monovalent substituent), P-Z (where Z represents a monovalent substituent), a group having alicycle, aromatic ring, or heterocycle, an alkylene group with carbon number of 1 to 4 or a group obtained by substituting at least part of hydrogen thereof with halogen or a trifluoromethyl group, or a group with carbon number of 1 to 4 having oxygen, sulfur, SO, SO₂, N—X (where X represents a monovalent substituent), or P-Z (where Z represents a monovalent substituent) between carbon atoms or a group obtained by substituting at least part of hydrogen thereof with halogen or a trifluoromethyl group. X81, X82, X83, and X84 represent a hydrogen group, a halogen group, or a trifluoromethyl group. At least one of X81 and X82 and at least one of X83 and X84 are a group having halogen.

According to the battery of the embodiment of the present invention, the electrolyte contains the cyclic ester derivative having halogen atom and at least one of the chain compounds expressed in Chemical formula 1 to Chemical formula 8. Therefore, decomposition reaction of the solvent in the anode can be inhibited, and cycle characteristics can be improved.

Further, when as the cyclic ester derivative, a cyclic carboxylate ester derivative or a cyclic ester carbonate derivative expressed in Chemical formula 9 is contained, cycle characteristics can be more improved.

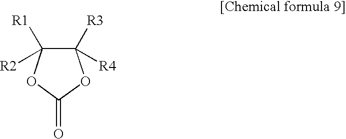

In the formula, R1, R2, R3, and R4 represent a hydrogen group, a fluorine group, a chlorine group, a bromine group, a methyl group, an ethyl group, or a group obtained by substituting part of hydrogen of a methyl group or an ethyl group with a fluorine group, a chlorine group, or a bromine group. At least one thereof is a group having halogen.

Further, when the content of the cyclic ester derivative and the chain compound is 40 volume % or more to the whole solvent, high effects can be obtained.

Additional features and advantages are described herein, and will be apparent from, the following Detailed Description and the figures.

### BRIEF DESCRIPTION OF THE FIGURES

FIG. 1 is a cross section showing a structure of a secondary battery according to an embodiment of the present invention.

FIG. 2 is a cross section showing an enlarged part of a spirally wound electrode body in the secondary battery shown in FIG. 1.

FIG. 3 is an exploded perspective view showing a structure of a secondary battery according to another embodiment of the present invention.

FIG. 4 is a cross section taken along line I-I of a spirally wound electrode body shown in FIG. 3; and

FIG. 5 shows a cross section showing a structure of a secondary battery fabricated in Examples.

### DETAILED DESCRIPTION

Embodiments of the present invention will be hereinafter described in detail with reference to the drawings.

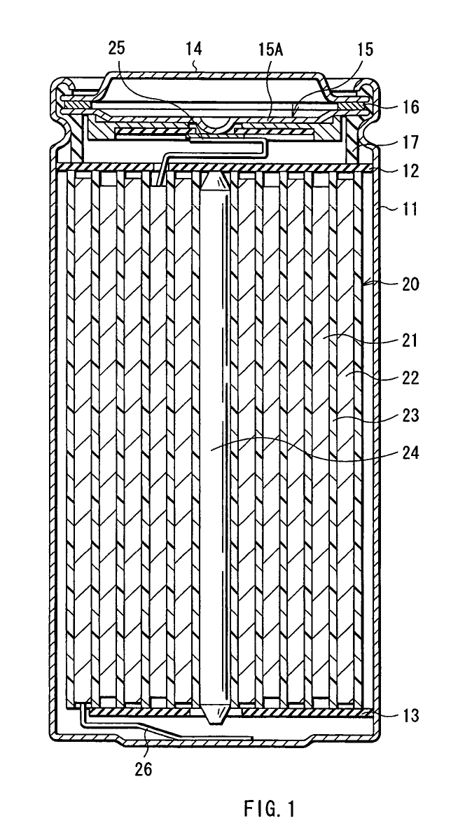

FIG. 1 shows a cross sectional structure of a secondary battery according to an embodiment of the present invention. The secondary battery is a so-called cylinder-type battery, and has a spirally wound electrode body 20 in which a strip-shaped cathode 21 and a strip-shaped anode 22 are layered with a separator 23 in between and wound inside a battery can 11 in the shape of approximately hollow cylinder. The battery can 11 is made of, for example, iron (Fe) plated by nickel (Ni). One end of the battery can 11 is closed, and the other end thereof is opened. Inside the battery can 11, a pair of insulating plates 12 and 13 is respectively arranged perpendicular to the winding periphery face, so that the spirally wound electrode body 20 is sandwiched between the insulating plates 12 and 13.

At the open end of the battery can 11, a battery cover 14, and a safety valve mechanism 15 and a PTC (Positive Temperature Coefficient) device 16 provided inside the battery cover 14 are attached by being caulked through a gasket 17. Inside of the battery can 11 is thereby hermetically sealed. The battery cover 14 is made of, for example, a material similar to that of the battery can 11. The safety valve mechanism 15 is electrically connected to the battery cover 14 through the PTC device 16. When the internal pressure of the battery becomes a certain level or more by internal short circuit, external heating or the like, a disk plate 15A flips to cut the electrical connection between the battery cover 14 and the spirally wound electrode body 20. When temperatures rise, the PTC device 16 limits a current by increasing the resistance value to prevent abnormal heat generation by a large current. The gasket 17 is made of, for example, an insulating material and its surface is coated with asphalt.

For example, a center pin 24 is inserted in the center of the spirally wound electrode body 20. A cathode lead 25 made of aluminum (Al) or the like is connected to the cathode 21 of the spirally wound electrode body 20. An anode lead 26 made of nickel or the like is connected to the anode 22. The cathode lead 25 is electrically connected to the battery cover 14 by being welded to the safety valve mechanism 15. The anode lead 26 is welded and electrically connected to the battery can 11.

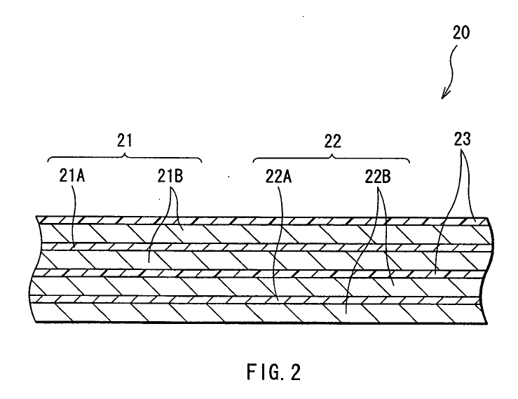

FIG. 2 shows an enlarged part of the spirally wound electrode body 20 shown in FIG. 1. The cathode 21 has, for example, a cathode current collector 21A having a pair of opposed faces and a cathode active material layer 21B provided on the both faces or the single face of the cathode current collector 21A. The cathode current collector 21A is, for example, made of a metal foil such as an aluminum foil, a nickel foil, and a stainless foil. The cathode active material layer 21B contains, for example, as a cathode active material, a cathode material capable of inserting and extracting lithium as the electrode reactant.

As a cathode material capable of inserting and extracting lithium, for example, lithium cobaltate, lithium nickelate, or a solid solution containing lithium cobaltate and lithium nickelate (Li(NiₓCo_{y}Mn_{z})O₂)) (values of x, y, and z are 0<x<1, 0<y<1, 0<z<1, and x+y+z=1), a lithium complex oxide such as manganese spinel (LiMn₂O₄), or a phosphate compound having an olivine structure such as lithium iron phosphate (LiFePO₄) is preferable, since a high energy density can be thereby obtained. Further, as a cathode material capable of inserting and extracting lithium, for example, an oxide such as titanium oxide, vanadium oxide, and manganese dioxide, a disulfide such as iron disulfide, titanium disulfide, and molybdenum disulfide, and a conductive macromolecule such as polyaniline and polythiophene can be cited. One of the foregoing cathode materials can be used singly, or two or more thereof can be used by mixing.

The cathode active material layer 21B contains, for example, an electrical conductor, and may further contain a binder if necessary. As an electrical conductor, for example, carbon materials such as graphite, carbon black, and Ketjen black can be cited. One thereof is used singly, or two or more thereof are used by mixing. Further, in addition to the carbon material, a metal material, a conductive high molecular weight material or the like may be used, as long as the material has conductivity. As a binder, for example, a synthetic rubber such as styrene butadiene rubber, fluorinated rubber, and ethylene propylene diene rubber, or a high molecular weight material such as polyvinylidene fluoride can be cited. One thereof is used singly, or two or more thereof are used by mixing. For example, when the cathode 21 and the anode 22 are wound as shown in FIG. 1, styrene butadiene rubber, fluorinated rubber or the like having flexibility is preferably used as a binder.

The anode 22 has, for example, an anode current collector 22A having a pair of opposed faces and an anode active material layer 22B provided on the both faces or the single face of the anode current collector 22A.

The anode current collector 22A is preferably made of a metal material containing at least one of metal elements not forming an intermetallic compound with lithium. When an intermetallic compound is formed with lithium, expansion and shrinkage due to charge and discharge occur to cause structural destruction, current collection characteristics are lowered, and an ability to support the anode active material layer 22B becomes lowered. As a metal element not forming an intermetallic compound with lithium, for example, copper (Cu), nickel, titanium (Ti), iron, or chromium (Cr) can be cited.

The anode active material layer 22B contains, for example, as an anode active material, an anode material capable of inserting and extracting lithium, which is the electrode reactant, and containing at least one of metal elements and metalloid elements as an element. When such an anode material is used, a high energy density can be obtained. Such an anode material may be a simple substance, an alloy, or a compound of a metal element or a metalloid element, or a material having one or more phases thereof at least in part. In the present invention, alloys include an alloy containing one or more metal elements and one or more metalloid elements in addition to an alloy including two or more metal elements. Further, an alloy may contain nonmetallic elements. The texture thereof includes a solid solution, a eutectic crystal (eutectic mixture), an intermetallic compound, and a texture in which two or more thereof coexist.

As a metal element or a metalloid element composing the anode material, for example, an element capable of forming an alloy with lithium such as magnesium (Mg), boron (B), aluminum, gallium (Ga), indium (In), silicon, germanium (Ge), tin, lead (Pb), bismuth (Bi), cadmium (Cd), silver (Ag), zinc (Z), hafnium (Hf), zirconium (Zr), yttrium (Y), palladium (Pd), and platinum (Pt) can be cited. These elements may be crystalline or amorphous.

Specially, as such an anode material, a material containing a metal element or a metalloid element of Group 4B in the short period periodic table as an element is preferable. A material containing at least one of silicon and tin as an element is particularly preferable. Silicon and tin have a high ability to insert and extract lithium, and can provide a high energy density.

As an alloy of tin, for example, an alloy containing at least one from the group consisting of silicon, nickel, copper, iron, cobalt, manganese, zinc, indium, silver, titanium (Ti), germanium, bismuth, antimony (Sb), and chromium (Cr) as a second element other than tin can be cited. As an alloy of silicon, for example, an alloy containing at least one from the group consisting of tin, nickel, copper, iron, cobalt, manganese, zinc, indium, silver, titanium, germanium, bismuth, antimony, and chromium as a second element other than silicon can be cited.

As a compound of tin or a compound of silicon, for example, a compound containing oxygen (O) or carbon (C) can be cited. In addition to tin or silicon, the compound may contain the foregoing second element.

The anode active material layer 22B may be formed by vapor-phase deposition method, liquid-phase deposition method, firing method, or coating. Firing method is a method, in which a particulate anode active material is mixed with a binder or a solvent according to needs, and then heat-treatment is performed at temperatures higher than the melting point of the binder or the like. Of the foregoing methods, in the case of using vapor-phase deposition method, liquid-phase deposition method, or firing method, the anode active material layer 22B and the anode current collector 22A are preferably alloyed at the interface thereof at least in part. Specifically, it is preferable that at the interface, elements of the anode current collector 22A are diffused in the anode active material layer 22B, or elements of the anode active material are diffused in the anode current collector 22A, or the both elements are diffused in each other. Thereby, destruction due to expansion and shrinkage of the anode active material layer 22B due to charge and discharge can be inhibited, and electron conductivity between the anode active material layer 22B and the anode current collector 22A can be improved.

Further, in the case of using coating, in addition to the foregoing anode material, other anode active material or other materials such as a binder, for example, polyvinylidene fluoride and an electrical conductor may be contained. The same applies to the case by firing method. As other anode active material, a carbon material capable of inserting and extracting lithium such as graphite, non-graphitizable carbon, and graphitizable carbon can be cited. In the case of using such a carbon material, change in the crystal structure occurring at charge and discharge is very little. For example, such a carbon material is preferably used with the foregoing anode material, since such a carbon material provides a high energy density and superior cycle characteristics, and functions as an electrical conductor as well.

The separator 23 separates the anode 22 from the cathode 21, prevents current short circuit due to contact of the both electrodes, and lets through lithium ions. The separator 23 is made of, for example, a synthetic resin porous film made of polytetrafluoroethylene, polypropylene, polyethylene or the like, or a ceramics porous film. The separator 23 may have a structure in which two or more of the foregoing porous films are layered.

For example, an electrolytic solution, which is the liquid electrolyte, is impregnated in the separator 23. The electrolytic solution contains, for example, a solvent and an electrolyte salt dissolved in the solvent.

As a solvent, a high dielectric constant solvent with a specific inductive capacity of 30 or more and a low viscosity solvent with a viscosity of 1 mPa·s or less can be cited. These two types of solvents are preferably used by mixing, since high ion conductivity can be thereby obtained.

As such a solvent, a cyclic ester derivative having halogen atom and a chain compound having halogen atom can be cited. These two types of solvents are preferably used by mixing, since decomposition reaction of the solvent in the anode 22 is thereby inhibited.

As a cyclic ester derivative having halogen atom, for example, a cyclic carboxylate ester derivative or a cyclic ester carbonate derivative expressed in Chemical formula 9 can be cited. One thereof may be used singly, or several kinds thereof may be used by mixing.

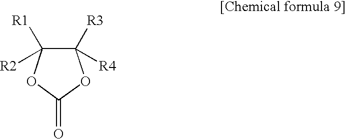

In the formula, R1, R2, R3, and R4 represent a hydrogen group, a fluorine group, a chlorine group, a bromine group, a methyl group, an ethyl group, or a group obtained by substituting part of hydrogen of a methyl group or an ethyl group with a fluorine group, a chlorine group, or a bromine group. At least one thereof is a group having halogen. R1, R2, R3, and R4 may be identical or different.

Specific examples of the cyclic carboxylate ester derivative include, for example, a cyclic carboxylate ester derivative obtained by substituting at least part of hydrogen of γ-butyrolactone or γ-valerolactone with halogen.

Specific examples of the cyclic ester carbonate derivative expressed in Chemical formula 9 include compounds expressed in (1-1) to (1-14) of Chemical formula 10 and compounds expressed in (1-15) to (1-21) of Chemical formula 11 and the like.

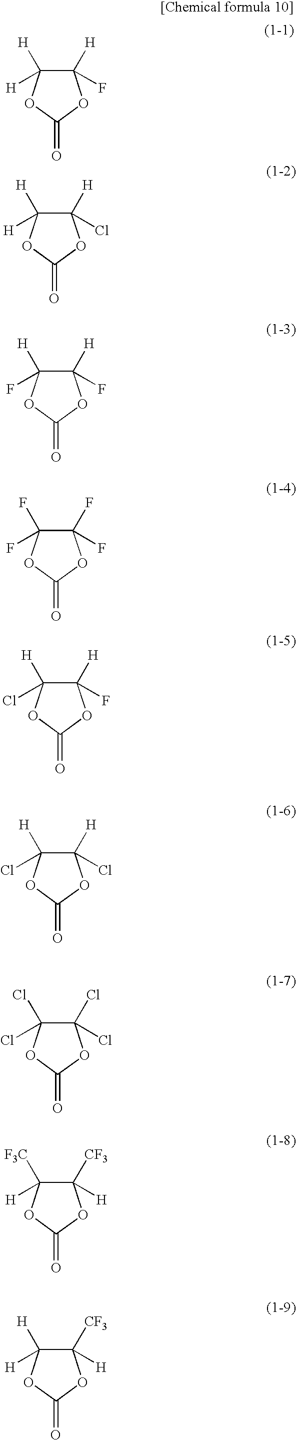

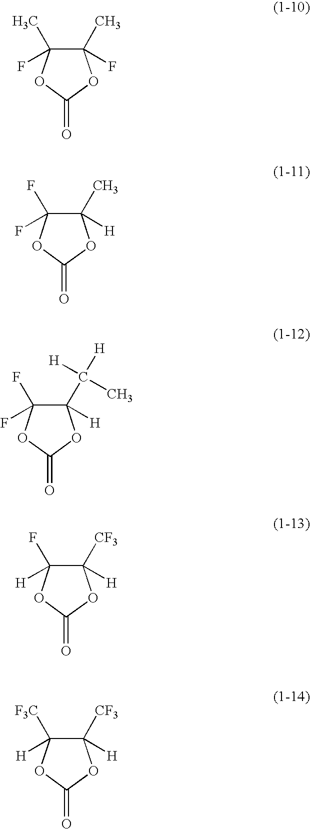

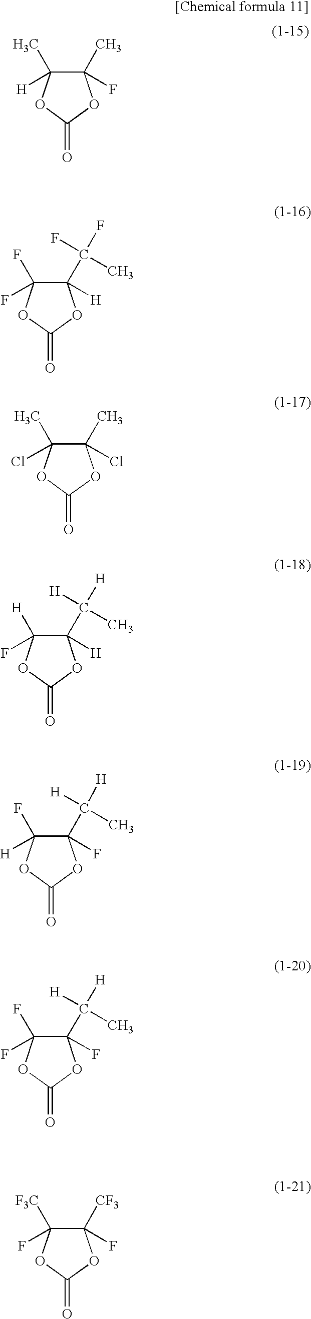

As a chain compound having halogen atom, for example, compounds expressed in Chemical formula 1 to Chemical formula 8 can be cited. One thereof may be used singly, or several kinds thereof may be used by mixing.

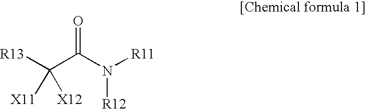

In the formula, R11 and R12 represent a hydrogen group, an alkyl group with carbon number of 1 to 15 or a group obtained by substituting at least part of hydrogen thereof with halogen, an alkoxyl group with carbon number of 2 to 15 or a group obtained by substituting at least part of hydrogen thereof with halogen, an aryl group with carbon number of 6 to 20 or a group obtained by substituting at least part of hydrogen thereof with halogen, a group obtained by substituting part of hydrogen of an alkyl group with carbon number of 7 to 20 with an aryl group or a group obtained by substituting at least part of hydrogen thereof with halogen, or an acyl group with carbon number of 1 to 15. R11 and R12 may be identical or different. R13 represents a hydrogen group, a halogen group, an alkyl group with carbon number of 1 to 20 or a group obtained by substituting at least part of hydrogen thereof with a substituent, an alkoxyl group with carbon number of 1 to 20 or a group obtained by substituting at least part of hydrogen thereof with a substituent, a group obtained by substituting at least part of hydrogen of an aryl group with carbon number of 7 to 20 with an alkoxyl group or a group obtained by substituting at least part of hydrogen thereof with other substituent, an acyl group with carbon number of 1 to 20 or a group obtained by substituting at least part of hydrogen thereof with a substituent, an aryl group with carbon number of 6 to 20 or a group obtained by substituting at least part of hydrogen thereof with halogen, or a heterocyclil group with carbon number of 4 to 20 or a group obtained by substituting at least part of hydrogen thereof with halogen. X11 and X12 represent a halogen group or a perfluoro alkyl group with carbon number of 1 to 10. X11 and X12 may be identical or different.

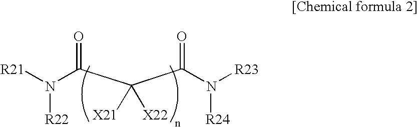

In the formula, R21, R22, R23, and R24 represent a hydrogen group, an alkyl group with carbon number of 1 to 15 or a group obtained by substituting at least part of hydrogen thereof with halogen, an alkoxyl group with carbon number of 2 to 15 or a group obtained by substituting at least part of hydrogen thereof with halogen, an aryl group with carbon number of 6 to 20 or a group obtained by substituting at least part of hydrogen thereof with halogen, a group obtained by substituting part of hydrogen of an alkyl group with carbon number of 7 to 20 with an aryl group or a group obtained by substituting at least part of hydrogen thereof with halogen, or an acyl group with carbon number of 1 to 15. R21, R22, R23, and R24 may be identical or different. X21 and X22 represent a halogen group or a perfluoro alkyl group with carbon number of 1 to 10. X21 and X22 may be identical or different. n represents an integer number from 1 to 4.

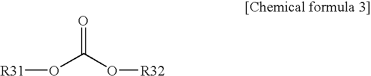

In the formula, R31 and R32 represent an alkyl group with carbon number of 1 to 5 or a group obtained by substituting at least part of hydrogen thereof with halogen. R31 and R32 may be identical or different. At least one thereof is a group having halogen.

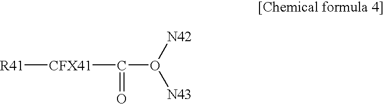

In the formula, R41 represents a hydrogen group, a fluorine group, a chlorine group, a bromine group, or an alkyl group with carbon number of 1 to 3 or a group obtained by substituting at least part of hydrogen thereof with halogen. X41 represents a hydrogen group, a fluorine group, a chlorine group, or a bromine group. R42 and R43 represent a methyl group or an ethyl group. R42 and R43 may be identical or different.

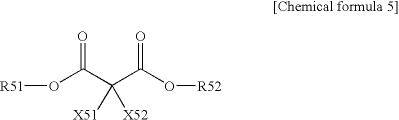

In the formula, R51 and R52 represent an alkyl group with carbon number of 1 to 3, an aryl group, or a group obtained by substituting at least part of hydrogen thereof with halogen. R 51 and R52 may be identical or different. X51 and X52 represent a hydrogen group, a halogen group, or a trifluoromethyl group. X51 and X52 may be identical or different. At least one thereof is a group having halogen.

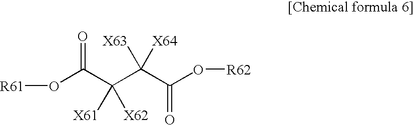

In the formula, R61 and R62 represent an alkyl group with carbon number of 1 to 3, an aryl group, or a group obtained by substituting at least part of hydrogen thereof with halogen. R 61 and R62 may be identical or different. X61, X62, X63, and X64 represent a hydrogen group, a halogen group, or a trifluoromethyl group. X61, X62, X63, and X64 may be identical or different. At least one of X61 and X62 and at least one of X63 and X64 are a group having halogen.

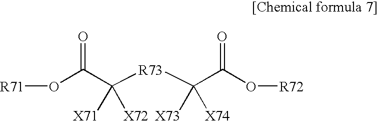

In the formula, R71 and R72 represent an alkyl group with carbon number of 1 to 3, an aryl group, or a group obtained by substituting at least part of hydrogen thereof with halogen. R71 and R72 may be identical or different. R73 represents oxygen, sulfur, SO, SO₂, N—X (where X represents a monovalent substituent), P-Z (where Z represents a monovalent substituent), a group having alicycle, aromatic ring or heterocycle, an alkylene group with carbon number of 1 to 4 or a group obtained by substituting at least part of hydrogen thereof with halogen or a trifluoromethyl group, or a group with carbon number of 1 to 4 having oxygen, sulfur, SO, SO₂, N—X (where X represents a monovalent substituent), or P-Z (where Z represents a monovalent substituent) between carbon atoms or a group obtained by substituting at least part of hydrogen thereof with halogen or a trifluoromethyl group. X71, X72, X73, and X74 represent a hydrogen group, a halogen group, or a trifluoromethyl group. X71, X72, X73, and X74 may be identical or different. At least one of X71 and X72 and at least one of X73 and X74 are a group having halogen.

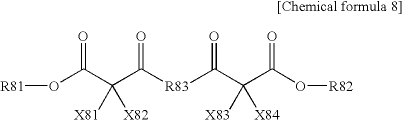

In the formula, R81 and R82 represent an alkyl group with carbon number of 1 to 3, an aryl group, or a group obtained by substituting at least part of hydrogen thereof with halogen. R81 and R82 may be identical or different. R83 represents oxygen, sulfur, SO, SO₂, N—X (where X represents a monovalent substituent), P-Z (where Z represents a monovalent substituent), a group having alicycle, aromatic ring, or heterocycle, an alkylene group with carbon number of 1 to 4 or a group obtained by substituting at least part of hydrogen thereof with halogen or a trifluoromethyl group, or a group with carbon number of 1 to 4 having oxygen, sulfur, SO, SO₂, N—X (where X represents a monovalent substituent), or P-Z (where Z represents a monovalent substituent) between carbon atoms or a group obtained by substituting at least part of hydrogen thereof with halogen or a trifluoromethyl group. X81, X82, X83, and X84 represent a hydrogen group, a halogen group, or a trifluoromethyl group. X81, X82, X83, and X84 may be identical or different. At least one of X81 and X82 and at least one of X83 and X84 are a group having halogen.

As a heterocyclic group or a group obtained by substituting at least part of hydrogen thereof with halogen of Chemical formula 1, for example, a group having carbon and one to three kinds of elements other than carbon in the heterocycle is preferable, a group having carbon and one to two kinds of elements other than carbon in the heterocycle is more preferable, and a group having one of sulfur, oxygen, and nitrogen and carbon is particularly desirable. Specific examples thereof include a pyridyl group, a furyl group, a benzofuranyl group, a thienyl group, a benzothienyl group, an indolyl group, a quinolyl group, a pyrrolyl group, and an imidazolyl group.

Specific examples of the compound expressed in Chemical formula 1 include compounds expressed in (2-1) to (2-4) of Chemical formula 12 and compounds expressed in (2-15) to (2-22) of Chemical formula 13.

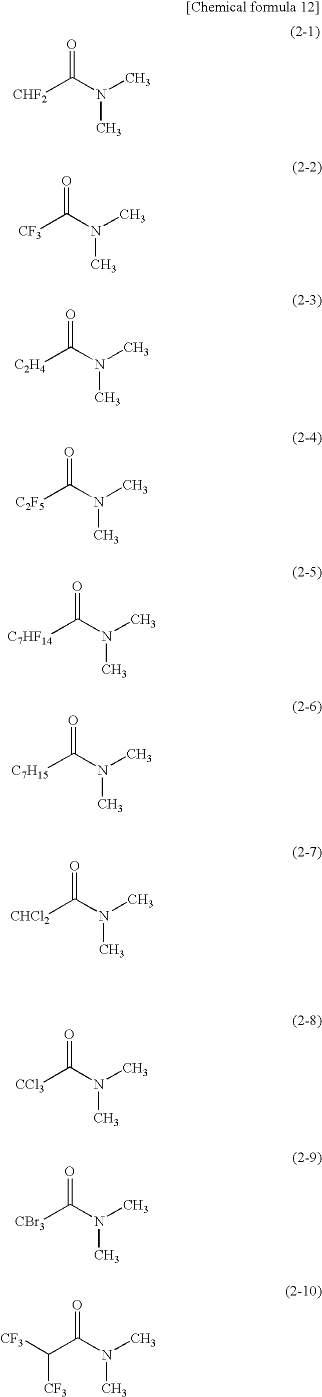

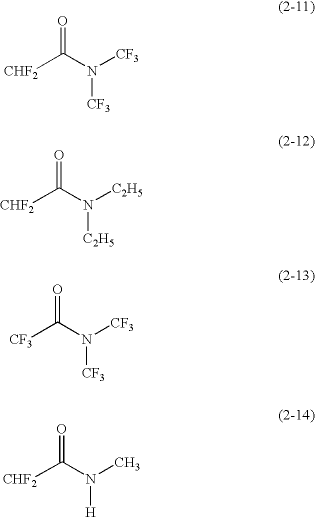

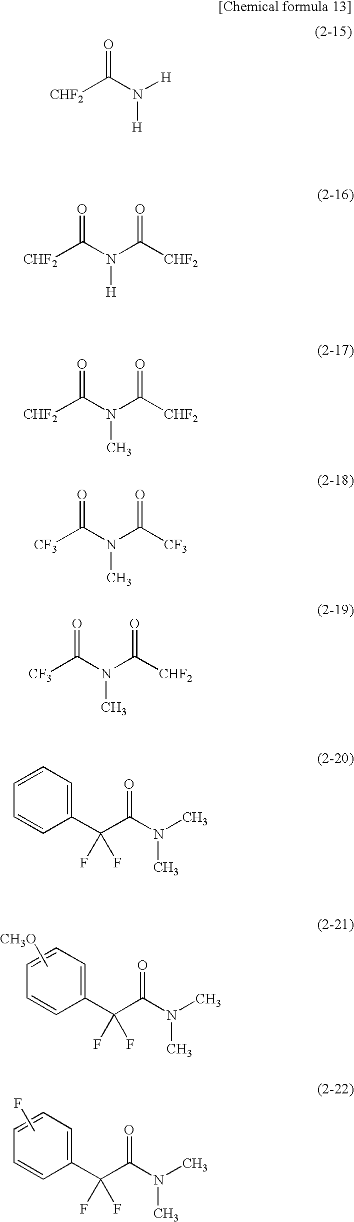

Specific examples of the compound expressed in Chemical formula 2 include compounds expressed in (3-1) to (3-3) of Chemical formula 14.

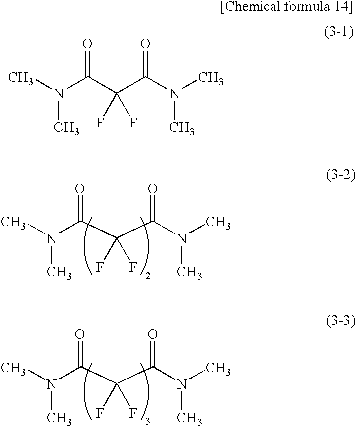

As a group obtained by substituting at least part of hydrogen of an alkyl group with halogen expressed by R31 and R32 of Chemical formula 3, for example, CF₃CH₂—, CF₃CF₂CH₂—, (CF₃)₂CH—, CH₂FCH₂—, CHF₂CH₂—, CCl₃CH₂—, CCl₃CCl₂CH₂—, (CCl₃)₂CH—, CH₂ClCH₂—, CHCl₂CH₂—, CBr₃CH₂—, CBr₃CBr₂CH₂—, (CBr₃)₂CH—, CH₂BrCH₂—, CHBr₂CH₂— and the like can be cited.

Specific examples of the compound expressed in Chemical formula 3 include CH₂FCH₂OCOOCH₂CH₂F, CHF₂CH₂OCOOCH₂CHF₂, CH₂FCH₂OCOOCH₃, CHF₂CH₂OCOOCH₃, CF₃CH₂OCOOCH₃, CF₃CH₂OCOOCH₂CF₃, CH₂ClCH₂OCOOCH₂CH₂Cl, CHCl₂CH₂OCOOCH₂CHCl₂, CH₂ClCH₂OCOOCH₃, CHCl₂CH₂OCOOCH₃, CCl₃CH₂OCOOCH₃, CCl₃CH₂OCOOCH₂CCl₃, CH₂BrCH₂OCOOCH₂CH₂Br, CHBr₂CH₂OCOOCH₂CHBr₂, CH₂BrCH₂OCOOCH₃, CHBr₂CH₂OCOOCH₃, CBr₃CH₂OCOOCH₃, and CBr₃CH₂OCOOCH₂CBr₃.

As a compound expressed in Chemical formula 4, a compound in which R41 is fluorine, chlorine, or bromine and X41 is hydrogen, a compound in which X41 is fluorine, chlorine, or bromine and R41 is hydrogen or an alkyl group, or a compound in which X41 is hydrogen and R41 is hydrogen or an alkyl group is preferable. A compound in which R41 is fluorine and X41 is hydrogen, a compound in which X41 is fluorine and R41 is hydrogen or an alkyl group, or a compound in which X41 is hydrogen and R41 is hydrogen or an alkyl group is more preferable. When an electron density of carbon in the alpha position of a carbonyl group becomes too small, reducing characteristics become high, which is not preferable. Specifically, CHF₂COON(CH₃)₂, CHF₂COON(C₂H₅)₂, CH₃CF₂COON(CH₃)₂, CH₃CF₂COON(C₂H₅)₂, CH₃CH₂CF₂COON(CH₃)₂, CH₃CH₂CF₂COON(C₂H₅)₂, C₃H₇CF₂COON(CH₃)₂, C₃H₇CF₂COON(C₂H₅)₂, CH₂FCOON(CH₃)₂, CH₂FCOON(C₂H₅)₂, CH₃CHFCOON(CH₃)₂, CH₃CHFCOON(C₂H₅)₂, CH₃CH₂CHFCOON(CH₃)₂, CH₃CH₂CHFCOON(C₂H₅)₂, C₃H₇CHFCOON(CH₃)₂, C₃H₇CHFCOON(C₂H₅)₂, CHCl₂COON(CH₃)₂, CHCl₂COON(C₂H₅)₂, CH₃CCl₂COON(CH₃)₂, CH₃CCl₂COON(C₂H₅)₂, CH₃CH₂CCl₂COON(CH₃)₂, CH₃CH₂CCl₂COON(C₂H₅)₂, C₃H₇CCl₂COON(CH₃)₂, C₃H₇CCl₂COON(C₂H₅)₂, CH₂ClCOON(CH₃)₂, CH₂ClCOON(C₂H₅)₂, CH₃CHClCOON(CH₃)₂, CH₃CHClCOON(C₂H₅)₂, CH₃CH₂CHClCOON(CH₃)₂, CH₃CH₂CHClCOON(C₂H₅)₂, C₃H₇CHClCOON(CH₃)₂, C₃H₇CHClCOON(C₂H₅)₂, CHBr₂COON(CH₃)₂, CHBr₂COON(C₂H₅)₂, CH₃CBr₂COON(CH₃)₂, CH₃CBr₂COON(C₂H₅)₂, CH₃CH₂CBr₂COON(CH₃)₂, CH₃CH₂CBr₂COON(C₂H₅)₂, C₃H₇CBr₂COON(CH₃)₂, C₃H₇CBr₂COON(C₂H₅)₂, CH₂BrCOON(CH₃)₂, CH₂BrCOON(C₂H₅)₂, CH₃CHBrCOON(CH₃)₂, CH₃CHBrCOON(C₂H₅)₂, CH₃CH₂CHBrCOON(CH₃)₂, CH₃CH₂CHBrCOON(C₂H₅)₂, C₃H₇CHBrCOON(CH₃)₂, C₃H₇CHBrCOON(C₂H₅)₂ or the like can be cited.

Specific examples of the groups expressed by R51, R52, R61, R62, R71, R72, R81, and R82 of Chemical formulas 5 to 8 include an alkyl group or a group obtained by substituting at least part of hydrogen thereof with halogen such as CH₃—, C₂H₅—, C₃H₇—, C₄H₉—, C₅H₁₁—, C₆H₁₃—, CH₂F—, CHF₂—, CF₃—, CH₂Cl—, CHCl₂—, CCl₃—, CH₂Br—, CHBr₂—, CBr₃—, CH₂I—, CHI₂—, C₁₃—, C₂H₄F—, C₂H₄Cl—, CF₃CH₂—, C₂HF₄—, C₂F₅—, C₃H₆F—, C₃H₆Cl—, C₃HF₆—, CF₃CF₂CH₂—, (CF₃)₂CH—, C₃F₇—, C₄H₈F—, C₄H₈Cl—, C₃F₇CH₂—, and C₄F₉—, an alkoxyalkyl group or a group obtained by substituting at least part of hydrogen thereof with halogen such as CH₃OCH₂—, C₂H₅OCH₂—, C₃H₇OCH₂—, CH₃OCH₂CH₂—, CH₃OCH₂CH₂CH₂—, CH₃OCH₂CH(CH₃)—, C₂H₅OCH₂CH₂—, C₃H₇OCH₂CH₂—, C₃H₇OCH₂CH₂CH₂—, CH₂FOCH₂—, CH₂ClOCH₂—, CH₃OCHF—, CF₃OCF₂—, CCl₃CH₂OCH₂—, CF₃CH₂OCH₂—, (CF₃)₂CHOCH₂—, CHF₂CF₂OCH₂—, CF₃CH₂OCH₂CH₂—, and CF₃CHFCF₂OCH₂—, an aryl group or a group obtained by substituting at least part of hydrogen thereof with halogen such as C₆H₅—, CH₃C₆H₄—, CH₃CH₂C₆H₄—, (CH₃)₂C₆H₃—, FC₆H₄—, F₂C₆H₃—, F₃C₆H₂—, F₄C₆H—, F₅C₆—, ClC₆H₄—, ClFC6H₃—, ClF₂C₆H₂—, Cl₂C₆H₃—, Cl₂F₃C₆—, BrC₆H₄—, BrF₂C₆H₂—, IC₆H₄—, F(CH₃)C₆H₃—, F(CH₃)₂C₆H₂—, CF₃C₆H₄—, (CF₃)₂C₆H₃—, (CF₃)₃C₆H₂—, and (CF₃)₂C₆F₃—, and an alkyl group having an aryl group as a substitution group or a group obtained by substituting at least part of hydrogen thereof with halogen such as C₆H₅CH₂—, C₆H₅CH₂CH₂—, CH₃C₆H₄CH₂—, FC₆H₄CH₂—, ClC₆H₄CH₂—, BrC₆H₄CH₂—, CF₃C₆H₄CH₂—, and FC₆H₄CH₂CH₂—.

Specific examples of the groups expressed by R73 or R83 of Chemical formula 7 and Chemical formula 8 include —CH₂—, —CH(CH₃)—, —S—, —SO—, —SO₂—, —N(CH₃)—, —P(C₆H₅)—, —C(CH₃)₂—, —CH₂CH₂—, —CH(CH₃)CH₂—, —C(CH₃)₂CH₂—, —CH₂OCH₂—, —CH(CH₃)CH(CH₃)—, —CH₂CH₂CH₂—, —CH₂C(CH₃)₂CH₂—, —CH₂CH₂CH₂CH₂—, —CH₂CH₂OCH₂CH₂—, —CH₂CH₂CH₂CH₂CH₂—, —CH₂N(CH₃)CH₂—, —CH₂SCH₂—, —CH₂SOCH₂—, —CH₂SO₂CH₂—, —CHF—, —CF₂—, —CH(CF₃)—, —CF(CF₃)—, —C(CF₃)₂—, —CHCl—, —CCl₂—, —CHBr—, —CBr₂—, —CHI—, —C₁₂—, —(CF₂)₂—, —CH(CF₃)CH₂—, —(CCl₂)₂—, —(CClF)₂—, —CH₂CF₂CH₂—, —CF₂OCF₂—, —CCl₂OCCl₂—, —CF₂OCH₂—, —CF₂C(CF₃)₂CF₂—, —CH₂CF₂CF₂CH₂—, —CF₂CH₂CH₂CF₂—, —CF(CF₃)CF₂CF₂CF(CF₃)—, —CCl(CF₃)CF₂CF₂CCl(CF₃)—, —CH₂CF₂CF₂CF₂CH₂—, —(CF₂)₄—, —(CF₂)₆—, —(CF₂)₈—, —(CF₂)₁₆—, —(CF₂)₂₀—, —(CF₂)₅₀—, —(CF₂)₄O(CF₂)₄—, —CF₂CF₂CF(CF₃)—, —CF₂N(CH₃)CF₂—, —CF₂SCF₂—, —CF₂SOCF₂—, —CF₂SO₂CF₂—, —C₆H₄—, —C₆H₃(CH₃)—, —C₆H₂(CH₃)₂—, —C₄H₆—, —C₆H₁₀—, —C₈H₁₄—, —C₅H₆(CF₃)₂—, —C₆H(CH₃)₃—, —C₆H₃(C₂H₅)—, —C₆H₂(C₂H₅)₂—, —C₆H₃(CF₃)—, —C₆H₂(CF₃)₂—, —C₆(CF₃)₄—, —C₆H₂(C₂F₅)₂—, —C₆H₃(C₄F₉)—, —C₆H₄C(CF₃)₂C₆H₄—, —C₆H₄C(CH₃)₂C₆H₄—, —C₁₀H₆—, —C₀₀H₅(CH₃)—, —C₁₀H₄(CH₃)₂—, —C₆H₄OC₆H₄—, —C₆H₄SC₆H₄—, —C₆H₄SOC₆H₄—, —C₆H₄SO₂C₆H₄—, —C₆H₄N(CH₃)C₆H₄—, —C₆H₃F—, —C₆H₃Cl—, —C₆H₃Br—, —C₆H₃I—, —C₆H₂F₂—, —C₆H₂Cl₂—, —C₆H₂Br₂—, —C₆H₂I₂—, —C₆HF₃—, —C₆HCl₃—, —C₆HBr₃—, —C₆F₄—, —C₆Cl₄—, —C₆H₃(CF₃)—, —C₆H₂(CF₃)₂—, —C₆(CF₃)₄—, —C₆F₂(C₂F₅)₂—, —C₆F₃(C₄F₉)—, —C₆F₄C(CF₃)₂C₆F₄—, —C₆F₄C(CH₃)₂C₆F₄—, —C₁₀H₅F—, —C₁₀H₅Cl—, —C₁₀H₅Br—, —C₁₀H₅I—, —C₁₀H₄F₂—, —C₁₀H₄Cl₂—, —C₁₀H₄Br₂—, —C₁₀H₄I₂—, —C₁₀H₃F₃—, —C₁₀H₃Cl₃—, —C₁₀H₂F₄—, —C₁₀H₂Cl₄—, —C₁₀HF₅—, —C₁₀HCl₅—, —C₁₀F₆—, —C₁₀Cl₆—, —C₆H₄C(CF₃)₂C₆H₄—, —C₆F₄OC₆F₄—, —C₆F₄SC₆F₄—, —C₆F₄SOC₆F₄—, —C₆F₄SO₂C₆F₄—, —C₆F₄N(CH₃)C₆F₄—, —C₄H₂S—, —C₅H₈₀—, and —C₆H₃(CF₂COOCH₃).

Specific examples of the compound expressed in Chemical formula 5 include a compound expressed in Chemical formula 15.

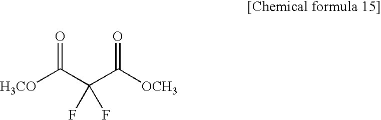

Specific examples of the compound expressed in Chemical formula 6 include compounds expressed in (4-1) to (4-10) of Chemical formula 16, compounds expressed in (4-11) to (4-16) of Chemical formula 17 and the like.

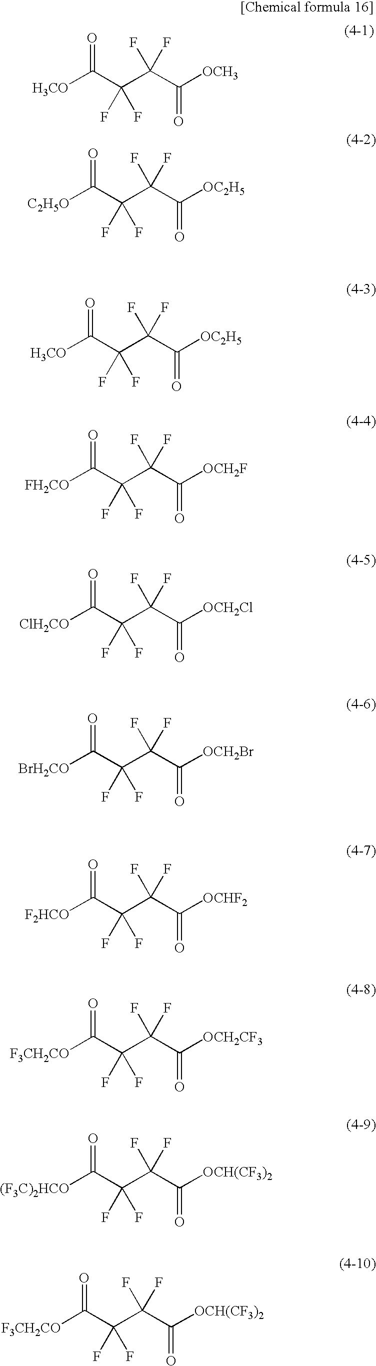

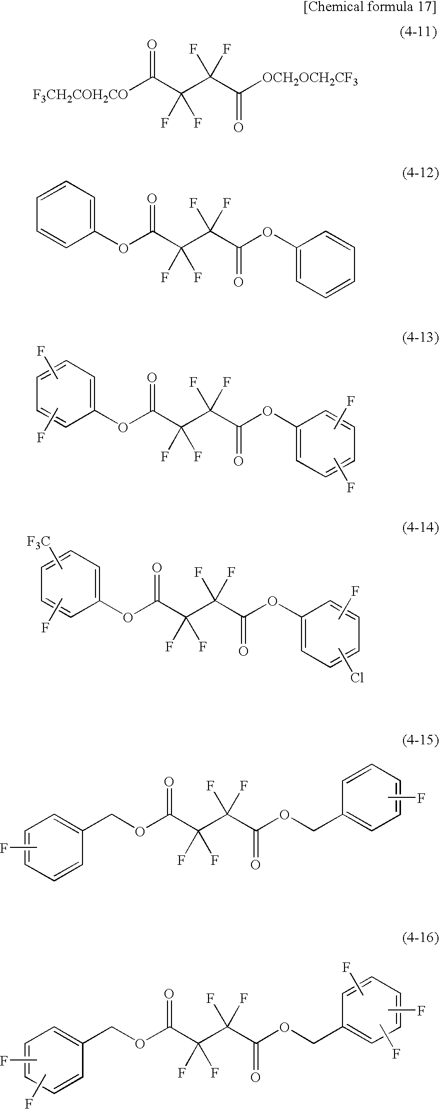

Specific examples of the compound expressed in Chemical formula 7 include compounds expressed in (5-1) to (5-10) of Chemical formula 18, compounds expressed in (5-11) to (5-19) of Chemical formula 19, compounds expressed in (5-20) to (5-23) of Chemical formula 20 and the like.

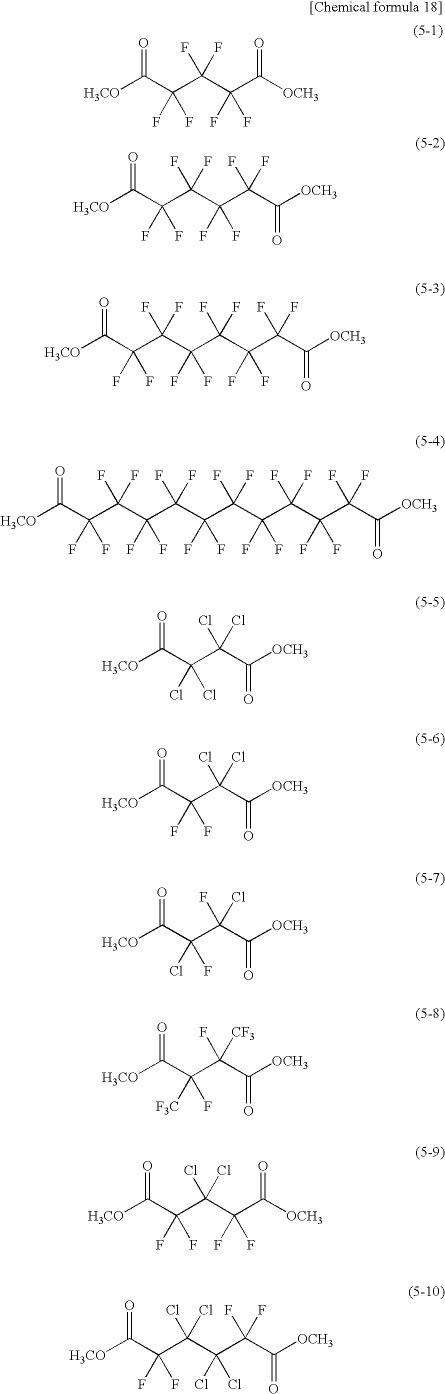

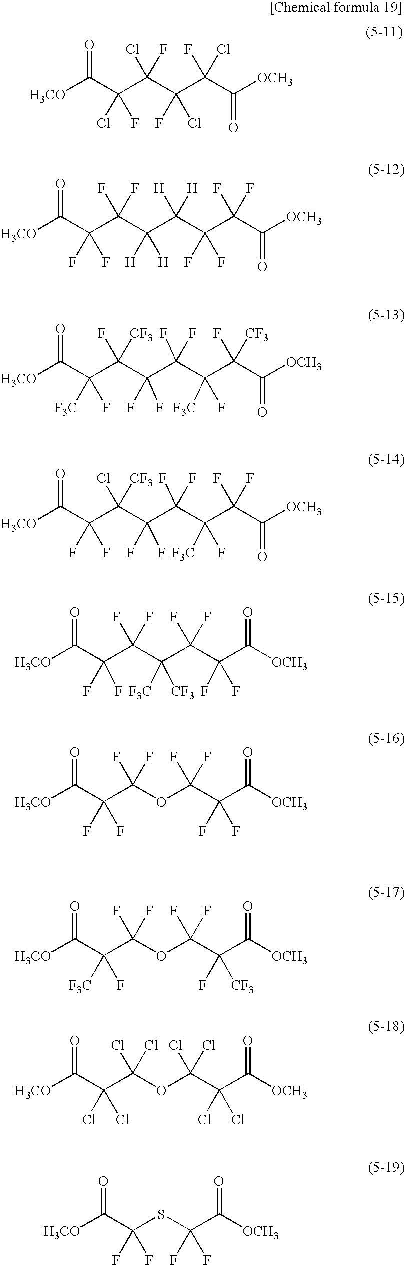

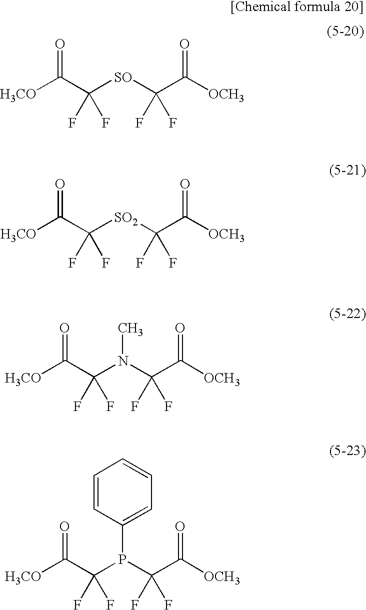

As a solvent, in addition to the foregoing solvents, other solvents may be mixed therewith in order to improve various battery characteristics. As other solvent, for example, ethylene carbonate, propylene carbonate, butylene carbonate, 1,3-dioxole-2-one, 4-vinyl-1,3-dioxole-2-one, γ-butyrolactone, γ-velerolactone, 1,2-dimethoxy ethane, tetrahydrofuran, 2-methyl tetrahydrofuran, 1,3-dioxolan, 4-methyl-1,3-dioxolan, methyl acetate, methyl propionate, ethyl propionate, dimethyl carbonate, ethyl methyl carbonate, diethyl carbonate, acetonitrile, glutaronitrile, adiponitrile, methoxy acetonitrile, 3-methoxy propylonitrile, N,N-dimethylformamide, N-methyl pyrolizinone, N-methyl oxazolizinone, N,N′-dimethyl imidazolizinone, nitromethane, nitroethane, sulfolane, dimethyl sulfoxide, and trimethyl phosphate can be cited. Specially, in order to realize superior charge and discharge capacity characteristics and charge and discharge cycle characteristics, at least one from the group consisting of ethylene carbonate, propylene carbonate, 1,3-dioxole-2-one, dimethyl carbonate, and ethyl methyl carbonate is preferably used. These other solvents may be used singly, or several kinds thereof may be used by mixing.

The content of the cyclic ester derivative having halogen atom and the chain compound having halogen atom in the solvent is preferably 40 volume % or more to the whole solvent. When the content is within the range, effects to inhibit decomposition reaction of the solvent in the anode 22 are high.

As an electrolyte salt, for example, a lithium salt such as LiB(C₆H₅)₄, LiCH₃SO₃, LiCF₃SO₃, LiAlCl₄, LiSiF₆, LiCi, LiBr, LiPF₆, LiBF₄, LiClO₄, LiAsF₆, LiN(CF₃SO₂)₂, LiN(C₂F₅SO₂)₂, LiN(C₄F₉SO₂)(CF₃SO₂) and LiC(CF₃SO₂)₃ can be cited.

Though the lithium salt is preferably used as an electrolyte salt, the lithium salt is not necessarily used. Lithium ions contributing to charge and discharge are enough if supplied from the cathode 21 and the like.

The content (concentration) of the electrolyte salt is preferably in the range from 0.3 mol/kg to 3.0 mol/kg to the solvent. If out of the range, sufficient battery characteristics may not be obtained due to significant decrease in ion conductivity.

The secondary battery can be manufactured, for example, as follows.

First, for example, the cathode 21 is formed by forming the cathode active material layer 21B on the cathode current collector 21A. The cathode active material layer 21B is formed, for example, as follows. Cathode active material powder, an electrical conductor, and a binder are mixed to prepare a cathode mixture, which is dispersed in a solvent such as N-methyl-2-pyrrolidone to obtain a paste cathode mixture slurry. Then, the cathode current collector 21A is coated with the cathode mixture slurry, which is dried and compression-molded, and then the cathode active material layer 21B is formed.

Further, for example, the anode 22 is formed by forming the anode active material layer 22B on the anode current collector 22A. The anode active material layer 22B may be formed by, for example, vapor-phase deposition method, liquid-phase deposition method, firing method, coating, or two or more of these methods. In the case that the anode active material layer 22B is formed by vapor-phase deposition method, liquid-phase deposition method, or firing method, the anode active material layer 22B and the anode current collector 22A may be alloyed at the interface thereof at least in part at the time of forming thereof. Further, it is possible to alloy the anode active material layer 22B and the anode current collector 22A by heat treatment under the vacuum atmosphere or the non-oxidizing atmosphere.

As vapor-phase deposition method, for example, physical deposition method or chemical deposition method can be used. Specifically, vacuum vapor deposition method, sputtering method, ion plating method, laser ablation method, thermal CVD (Chemical Vapor Deposition) method, plasma CVD method and the like are available. As liquid-phase deposition method, a known technique such as electrolytic plating and electroless plating is available. For firing method, a known technique such as atmosphere firing method, reactive firing method, and hot press firing method is available. In the case of coating, the anode active material layer 22B can be formed as in cathode 21.

Next, the cathode lead 25 is attached to the cathode current collector 21A by welding or the like, and the anode lead 26 is attached to the anode current collector 22A by welding or the like. Subsequently, the cathode 21 and the anode 22 are wound with the separator 23 in between. The end of the cathode lead 25 is welded to the safety valve mechanism 15, and the end of the anode lead 26 is welded to the battery can 11. The wound cathode 21 and the wound anode 22 are sandwiched between the pair of insulating plates 12 and 13, and contained inside the battery can 11. After the cathode 21 and the anode 22 are contained inside the battery can 11, the electrolytic solution is injected into the battery can 11 and impregnated in the separator 23. After that, at the open end of the battery can 11, the battery cover 14, the safety valve mechanism 15, and the PTC device 16 are fixed by being caulked through the gasket 17. The secondary battery shown in FIG. 1 is thereby completed.

In the secondary battery, when charged, for example, lithium ions are extracted from the cathode 21 and inserted in the anode 22 through the electrolytic solution. When discharged, for example, lithium ions are extracted from the anode 22, and inserted in the cathode 21 through the electrolytic solution. Then, as described above, the electrolytic solution contains the cyclic ester derivative having halogen atom and at least one of chain ester expressed in Chemical formula 1 to Chemical formula 8, and therefore decomposition reaction of the solvent in the anode 22 is inhibited.

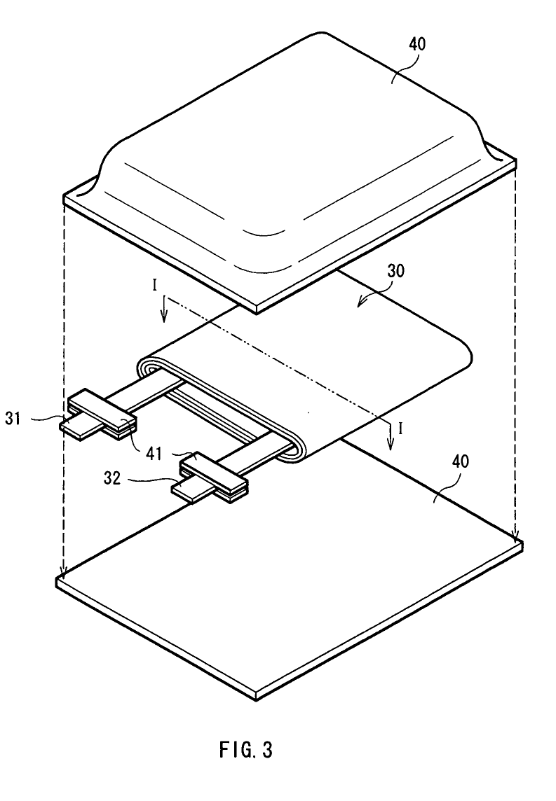

FIG. 3 shows a structure of a secondary battery according to another embodiment of the present invention. In the secondary battery, a spirally wound electrode body 30 on which a cathode lead 31 and an anode lead 32 are attached is contained inside a film package member 40. Therefore, the size, the weight, and the thickness thereof can be reduced.

The cathode lead 31 and the anode lead 32 are respectively directed from inside to outside of the package member 40 in the same direction, for example. The cathode lead 31 and the anode lead 32 are respectively made of, for example, a metal material such as aluminum, copper, nickel, and stainless, and are in the shape of thin plate or mesh.

The package member 40 is made of a rectangular aluminum laminated film in which, for example, a nylon film, an aluminum foil, and a polyethylene film are bonded together in this order. The package member 40 is, for example, arranged so that the polyethylene film side and the spirally wound electrode body 30 are opposed, and the respective outer edges are contacted to each other by fusion bonding or an adhesive. Adhesive films 41 to protect from outside air intrusion are inserted between the package member 40 and the cathode lead 31, the anode lead 32. The adhesive film 41 is made of a material having contact characteristics to the cathode lead 31 and the anode lead 32 such as a polyolefin resin of polyethylene, polypropylene, modified polyethylene, and modified polypropylene.

The package member 40 may be made of a laminated film having other structure, a polymeric film such as polypropylene, or a metal film, instead of the foregoing aluminum laminated film.

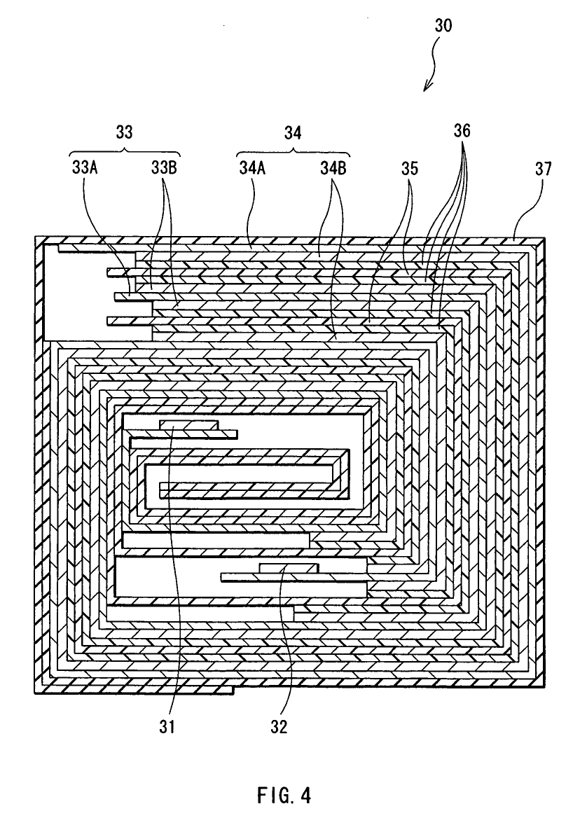

FIG. 4 shows a cross sectional structure taken along line I-I of the spirally wound electrode body 30 shown in FIG. 3. In the spirally wound electrode body 30, a cathode 33 and an anode 34 are layered with a separator 35 and an electrolyte layer 36 in between and wound. The outermost periphery thereof is protected by a protective tape 37.

The cathode 33 has a structure in which a cathode active material layer 33B is provided on the single face or the both faces of a cathode current collector 33A. The anode 34 has a structure in which an anode active material layer 34B is provided on the single face or the both faces of an anode current collector 34A. Arrangement is made so that the anode active material layer 34B side is opposed to the cathode active material layer 33B. Structures of the cathode current collector 33A, the cathode active material layer 33B, the anode current collector 34A, the anode active material layer 34B, and the separator 35 are similar to of the cathode current collector 21A, the cathode active material layer 21B, the anode current collector 22A, the anode active material layer 22B, and the separator 23 respectively described above.

The electrolyte layer 36 is gelatinous, containing an electrolytic solution and a high molecular weight compound to become a holding body, which holds the electrolytic solution. The gelatinous electrolyte layer 36 is preferable, since high ion conductivity can be thereby obtained and leak of the battery can be thereby prevented. The structure of the electrolytic solution (that is, a solvent, an electrolyte salt and the like) is similar to of the cylinder-type secondary battery shown in FIG. 1. As a high molecular weight compound, for example, an ether high molecular weight compound such as polyethylene oxide and a crosslinking body containing polyethylene oxide, an ester high molecular weight compound such as polymethacrylate or an acrylate high molecular weight compound, or a polymer of vinylidene fluoride such as polyvinylidene fluoride and a copolymer of vinylidene fluoride and hexafluoropropylene can be cited. One or more thereof are used by mixing. In particular, in view of redox stability, the fluorinated high molecular weight compound such as the polymer of vinylidene fluoride is desirably used.

The secondary battery can be manufactured, for example, as follows.

First, the cathode 33 and the anode 34 are respectively coated with a precursor solution containing a solvent, an electrolyte salt, a high molecular weight compound, and a mixed solvent. The mixed solvent is volatilized to form the electrolyte layer 36. After that, the cathode lead 31 is attached to the end of the cathode current collector 33A by welding, and the anode lead 32 is attached to the end of the anode current collector 34A by welding. Next, the cathode 33 and the anode 34 formed with the electrolyte layer 36 are layered with the separator 35 in between to obtain a lamination. After that, the lamination is wound in the longitudinal direction, the protective tape 37 is adhered to the outermost periphery thereof to form the spirally wound electrode body 30. Lastly, for example, the spirally wound electrode body 30 is sandwiched between the package members 40, and outer edges of the package members 40 are contacted by thermal fusion-bonding or the like to enclose the spirally wound electrode body 30. Then, the adhesive films 41 are inserted between the cathode lead 31, the anode lead 32 and the package member 40. Thereby, the secondary battery shown in FIG. 3 and FIG. 4 is completed.

Further, the secondary battery may be fabricated as follows. First, as described above, the cathode 33 and the anode 34 are formed, and the cathode lead 31 and the anode lead 32 are attached on the cathode 33 and the anode 34. After that, the cathode 33 and the anode 34 are layered with the separator 35 in between and wound. The protective tape 37 is adhered to the outermost periphery thereof, and a winding body, which is the precursor of the spirally wound electrode body 30, is formed. Next, the winding body is sandwiched between the package members 40, the outermost peripheries except for one side are thermal fusion-bonded to obtain a pouched state, and the winding body is contained inside the package member 40. Subsequently, a composition of matter for electrolyte containing a solvent, an electrolyte salt, a monomer as the raw material for the high molecular weight compound, a polymerization initiator, and if necessary other material such as a polymerization inhibitor is prepared, which is injected into the package member 40.

After the composition of matter for electrolyte is injected, the opening of the package member 40 is thermal fusion-bonded and hermetically sealed in the vacuum atmosphere. Next, the resultant is heated to polymerize the monomer to obtain a high molecular weight compound. Thereby, the gelatinous electrolyte layer 36 is formed, and the secondary battery shown in FIG. 3 is assembled.

As above, according to the battery of this embodiment, the cyclic ester derivative having halogen atom and at least one of the chain compounds expressed in Chemical formula 1 to Chemical formula 8 are contained in the electrolyte. Therefore, decomposition reaction of the solvent in the anode 22 can be inhibited, and cycle characteristics can be improved.

Further, when as a cyclic ester derivative, a cyclic carboxylate ester derivative or the cyclic ester carbonate derivative expressed in Chemical formula 9 is contained, cycle characteristics can be more improved.

Further, when the content of the cyclic ester derivative and the chain compound is 40 volume % or more to the whole solvent, high effects can be obtained.

### EXAMPLES

Further, specific examples of the present invention will be described in detail.

### Examples 1-1 to 1-7

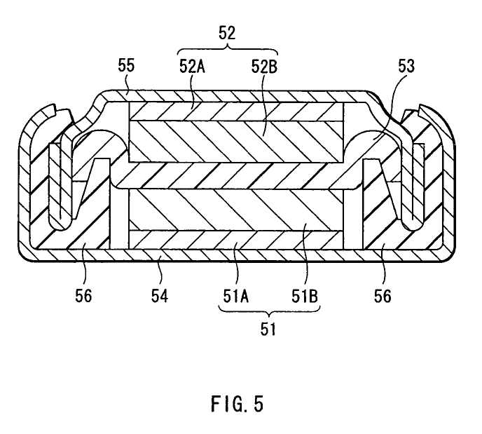

The coin-type secondary battery shown in FIG. 5 was fabricated. In the secondary battery, a cathode 51 and an anode 52 were layered with a separator 53 impregnated with an electrolytic solution in between, and the lamination was sandwiched between a package can 54 and a package cup 55 and was caulked through a gasket 56. First, 94 parts by weight of lithium cobalt complex oxide (LiCoO₂) as the cathode active material, 3 parts by weight of graphite as the electrical conductor, 3 parts by weight of polyvinylidene fluoride as the binder were mixed. After that, N-methyl-2-pyrrolidone was added to the mixture to obtain cathode mixture slurry. Next, a cathode current collector 51A made of an aluminum foil being 20 μm thick was uniformly coated with the obtained cathode mixture slurry, which was dried to form a cathode active material layer 51B being 70 μm thick. After that, the cathode current collector 51A formed with the cathode active material layer 51B was punched out into a circle being 16 mm in diameter to form the cathode 51.

Further, an anode active material layer 52B made of silicon being 5 μm thick was formed on an anode current collector 52A made of a copper foil being 15 μm thick by sputtering method. After that, the anode current collector 52A formed with the anode active material layer 52B was punched out into a circle being 16 mm in diameter to form the anode 52.

Next, the cathode 51 and the anode 52 were layered with the separator 53 made of a microporous polypropylene film being 25 μm thick in between. After that, 0.1 g of an electrolytic solution was injected into the separator 53. The resultant was contained in the package cup 55 and the package can 54 made of stainless, which were caulked to obtain the secondary battery shown in FIG. 5. For the electrolytic solution, an electrolytic solution obtained by dissolving lithium phosphate hexafluoride (LiPF₆) as an electrolyte salt in a mixed solvent of a cyclic ester derivative having halogen atom and a chain compound having halogen atom at a volume ratio of 50:50 so that lithium phosphate hexafluoride became 1 mol/kg was used. Then, as a cyclic ester derivative, 4-fluoro-1,3-dioxolan-2-one was used. As a chain compound, CF₃CON(CH₃)₂, CHF₂CON(CH₃)₂, CF₃CH₂OCOOCH₃, CF₃CH₂OCOOCH₂CF₃, CH₃OCOCF₂OCOCH₃, CH₃OCO(CF₂)₂OCOCH₃, or CH₃OCO(CF₂)₃OCOCH₃ was used.

As Comparative examples 1-1 and 1-2 relative to Examples 1-1 to 1-7, secondary batteries were fabricated as in Examples 1-1 to 1-7, except that a mixed solvent of 4-fluoro-1,3-dioxolan-2-one as the cyclic ester derivative and dimethyl carbonate at a volume ratio of 50:50 was used or a mixed solvent of ethylene carbonate and CF₃CH₂OCOOCH₃ as the chain compound at a volume ratio of 50:50 was used.

Further, as Comparative examples 1-3 to 1-5, secondary batteries were fabricated as in Examples 1-1 to 1-7, except that a mixed solvent of 4-fluoro-1,3-dioxolan-2-one as the cyclic ester derivative and CF₃CH₂OCOOCH₃ as the chain compound at a volume ratio of 50:50 was used, or a mixed solvent of 4-fluoro-1,3-dioxolan-2-one as the cyclic ester derivative and dimethyl carbonate at a volume ratio of 50:50 was used, or a mixed solvent of ethylene carbonate and CF₃CH₂OCOOCH₃ as the chain compound at a volume ratio of 50:50 was used. Then, graphite powder was prepared as an anode active material. 97 parts by weight of the graphite powder and 3 parts by weight of polyvinylidene fluoride as the binder were mixed. Then, N-methyl-2-pyrrolidone as the solvent was added to the mixture. Next, an anode current collector 52A made of a strip-shaped copper foil being 15 μm thick was uniformly coated with the resultant, which was dried and compression-molded by a rolling press machine to form the anode active material layer 52B. Consequently, the anode 52 was formed.

For the obtained secondary batteries of Examples 1-1 to 1-7 and Comparative examples 1-1 to 1-5, charge was performed at 1.77 mA setting the upper limit of 4.2 V for 12 hours, and then charge was stopped for 10 minutes. After that, discharge was performed at 1.77 mA until reaching 2.5 V. Such charge and discharge were repeated to obtain the discharge capacity retention ratio at the 50th cycle. The discharge capacity retention ratio at the 50th cycle was calculated as (discharge capacity at the 50th cycle/discharge capacity at the initial cycle)×100. The obtained results are shown in Table 1.

TABLE 1

| | | | Discharge |
|---|---|---|---|
| | Anode | | capacity |
| | active | | retention |
| | material | Solvent | ratio (%) |
| Example 1-1 | Si | FEC + CF₃CON(CH₃)₂ | 84.0 |
| Example 1-2 | | FEC + CHF₂CON(CH₃)₂ | 83.0 |
| Example 1-3 | | FEC + CF₃CH₂OCOOCH₃ | 86.0 |
| Example 1-4 | | FEC + CF₃CH₂OCOOCH₂CF₃ | 87.0 |
| Example 1-5 | | FEC + CH₃OCOCF₂OCOCH₃ | 75.0 |
| Example 1-6 | | FEC + CH₃OCO(CF₂)₂OCOCH₃ | 72.0 |
| Example 1-7 | | FEC + CH₃OCO(CF₂)₃OCOCH₃ | 70.0 |
| Comparative | Si | FEC + dimethyl carbonate | 65.0 |
| example 1-1 | | | |
| Comparative | | EC + CF₃CH₂OCOOCH₃ | 55.0 |
| example 1-2 | | | |
| Comparative | Graphite | FEC + CF₃CH₂OCOOCH₃ | 94.0 |
| example 1-3 | | | |
| Comparative | | FEC + dimethyl carbonate | 94.0 |
| example 1-4 | | | |
| Comparative | | EC + CF₃CH₂OCOOCH₃ | 93.0 |
| example 1-5 | | | |

FEC: 4-fluoro-1,3-dioxolan-2-one
EC: ethylene carbonate

As evidenced by Table 1, according to Examples 1-1 to 1-7 using the mixed solvent of the cyclic ester derivative having halogen atom and the chain compound having halogen atom, the discharge capacity retention ratio was improved more than in Comparative example 1-1 not mixing the chain compound having halogen atom or Comparative example 1-2 not mixing the cyclic ester derivative having halogen atom. Further, according to Comparative examples 1-3 to 1-5 using graphite for the anode active material, the discharge capacity retention ratio was hardly improved even if the mixed solvent of the cyclic ester derivative having halogen atom and the chain compound having halogen atom was used.

That is, it was found that when the mixed solvent of the cyclic ester derivative having halogen atom and the chain compound having halogen atom was used, cycle characteristics could be improved as long as the anode material capable of inserting and extracting the electrode reactant and containing a metal element as an element was used.

### Examples 2-1 to 2-3

Secondary batteries were fabricated as in Example 1-3, except that other cyclic ester derivative having halogen atom instead of 4-fluoro-1,3-dioxolan-2-one was used. Then, as other cyclic ester derivative having halogen atom, 4-trifluoromethyl-1,3-dioxolan-2-one, 4-chloro-1,3-dioxolan-2-one, or fluoro-γ-butyrolactone was used.

For the obtained secondary batteries of Examples 2-1 to 2-3, cycle characteristics were measured as in Examples 1-1 to 1-7. The results are shown in Table 2.

TABLE 2

| | | | Discharge |
|---|---|---|---|
| | | | capacity |
| | Anode active | | retention |
| | material | Solvent | ratio (%) |
| Example 1-3 | Si | FEC + CF₃CH₂OCOOCH₃ | 86.0 |
| Example 2-1 | | TFPC + CF₃CH₂OCOOCH₃ | 75.0 |
| Example 2-2 | | CIEC + CF₃CH₂OCOOCH₃ | 80.1 |
| Example 2-3 | | FGBL + CF₃CH₂OCOOCH₃ | 82.0 |

FEC: 4-fluoro-1,3-dioxolan-2-one
TFPC: 4-trifluoromethyl-1,3-dioxolan-2-one
CIEC: 4-chloro-1,3-dioxolan-2-one
FGBL: fluoro-γ-butyrolactone

As evidenced by Table 2, the results similar to of Example 1-3 were obtained. That is, it was found that when other cyclic ester derivative having halogen atom was used, cycle characteristics could be improved.

### Examples 3-1 to 3-4,4-1 to 4-4,5-1, 5-2,6-1, and 6-2

As Examples 3-1 to 3-4, secondary batteries were fabricated as in Example 1-3, except that γ-butyrolactone as the solvent was further added, and the content of 4-fluoro-1,3-dioxolan-2-one and CF₃CH₂OCOOCH₃ in the solvent was changed. Then, 4-fluoro-1,3-dioxolan-2-one:CF₃CH₂OCOOCH₃:γ-butyrolactone (volume ratio) was respectively 30:30:40, 20:20:60, 20:10:70, or 10:10:80. That is, the content of 4-fluoro-1,3-dioxolan-2-one and CF₃CH₂OCOOCH₃ was respectively 60 volume %, 40 volume %, 30 volume %, or 20 volume %.

As Examples 4-1 to 4-4, secondary batteries were fabricated as in Example 1-3, except that propylene carbonate as the solvent was further added, and the content of 4-fluoro-1,3-dioxolan-2-one and CF₃CH₂OCOOCH₃ in the solvent was changed. Then, 4-fluoro-1,3-dioxolan-2-one:CF₃CH₂OCOOCH₃:propylene carbonate (volume ratio) was respectively 30:30:40, 20:20:60, 20:10:70, or 10:10:80. That is, the content of 4-fluoro-1,3-dioxolan-2-one and CF₃CH₂OCOOCH₃ was respectively 60 volume %, 40 volume %, 30 volume %, or 20 volume %.

As Examples 5-1 and 5-2, secondary batteries were fabricated as in Example 1-3, except that dimethyl carbonate as the solvent was further added, and the content of 4-fluoro-1,3-dioxolan-2-one and CF₃CH₂OCOOCH₃ in the solvent was changed. Then, 4-fluoro-1,3-dioxolan-2-one:CF₃CH₂OCOOCH₃:dimethyl carbonate (volume ratio) was respectively 30:30:40 or 20:20:60. That is, the content of 4-fluoro-1,3-dioxolan-2-one and CF₃CH₂OCOOCH₃ was respectively 60 volume % or 40 volume %.

As Examples 6-1 and 6-2, secondary batteries were fabricated as in Example 1-4, except that γ-butyrolactone or propylene carbonate as the solvent was further added, and the content of 4-fluoro-1,3-dioxolan-2-one and CF₃CH₂OCOOCH₂CF₃ in the solvent was 60 volume %. Then, 4-fluoro-1,3-dioxolan-2-one:CF₃CH₂OCOOCH₂CF₃:γ-butyrolactone (volume ratio) and 4-fluoro-1,3-dioxolan-2-one:CF₃CH₂OCOOCH₂CF₃:propylene carbonate (volume ratio) were 30:30:40.

For the obtained secondary batteries of Examples 3-1 to 3-4,4-1 to 4-4,5-1, 5-2,6-1, and 6-2, cycle characteristics were measured as in Examples 1-1 to 1-7. The results are shown in Table 3. The numerical values in parentheses shown in Table 3 are values expressing the content of each solvent by volume %. The same is hereinafter applied to other tables.

TABLE 3

| | | | Discharge |
|---|---|---|---|
| | | | capacity |
| | Anode active | | retention ratio |
| | material | Solvent | (%) |
| Example 1-3 | Si | FEC (50) + CF₃CH₂OCOOCH₃ (50) | 86.0 |
| Example 3-1 | | FEC (30) + CF₃CH₂OCOOCH₃ (30) + GBL (40) | 85.0 |
| Example 3-2 | | FEC (20) + CF₃CH₂OCOOCH₃ (20) + GBL (60) | 82.4 |
| Example 3-3 | | FEC (20) + CF₃CH₂OCOOCH₃ (10) + GBL (70) | 65.5 |
| Example 3-4 | | FEC (10) + CF₃CH₂OCOOCH₃ (10) + GBL (80) | 60.0 |
| Example 4-1 | | FEC (30) + CF₃CH₂OCOOCH₃ (30) + PC (40) | 86.5 |
| Example 4-2 | | FEC (20) + CF₃CH₂OCOOCH₃ (20) + PC (60) | 83.4 |
| Example 4-3 | | FEC (20) + CF₃CH₂OCOOCH₃ (10) + PC (70) | 67.5 |
| Example 4-4 | | FEC (10) + CF₃CH₂OCOOCH₃ (10) + PC (80) | 63.0 |
| Example 5-1 | | FEC (30) + CF₃CH₂OCOOCH₃ (30) + DMC (40) | 83.5 |
| Example 5-2 | | FEC (20) + CF₃CH₂OCOOCH₃ (20) + DMC (60) | 82.0 |
| Example 1-4 | | FEC (50) + CF₃CH₂OCOOCH₂CF₃ (50) | 87.0 |
| Example 6-1 | | FEC (30) + CF₃CH₂OCOOCH₂CF₃ (30) + GBL (40) | 87.5 |
| Example 6-2 | | FEC (30) + CF₃CH₂OCOOCH₂CF₃ (30) + PC (40) | 88.8 |

FEC: 4-fluoro-1,3-dioxolan-2-one
PC: propylene carbonate
DMC: dimethyl carbonate
GBL: γ-butyrolactone

As evidenced by Table 3, in Examples 3-1,3-2, 4-1,4-2, 5-1,5-2, 6-1, and 6-2, in which the content of 4-fluoro-1,3-dioxolan-2-one and CF₃CH₂OCOOCH₃ or the content of 4-fluoro-1,3-dioxolan-2-one and CF₃CH₂OCOOCH₂CF₃ was 40 volume % or more, the high discharge capacity retention ratio was obtained.

That is, it was found that the content of the cyclic ester derivative having halogen atom and the chain compound having halogen atom in the solvent was preferably 40 volume % or more.

### Examples 7-1,7-2, 8-1, and 8-2

As Examples 7-1 and 7-2, coin-type secondary batteries were fabricated as in Examples 1-3 and 1-4, except that tin was used for the anode active material and the anode active material layer 52B made of tin being 5 am thick was formed on the anode current collector 52A made of a copper foil being 15 μm thick by vacuum vapor deposition method. That is, as a cyclic ester derivative in the electrolytic solution, 4-fluoro-1,3-dioxolan-2-one was used, and as a chain compound, CF₃CH₂OCOOCH₃ or CF₃CH₂OCOOCH₂CF₃ was used.

As Examples 8-1 and 8-2, coin-type secondary batteries were fabricated as in Examples 1-3 and 1-4, except that tin-cobalt alloy at a weight ratio of tin:cobalt=72:28 was used for an anode active material, 94 parts by weight of the tin-cobalt alloy, 3 parts by weight of graphite as the electrical conductor, 3 parts by weight of polyvinylidene fluoride as the binder were mixed, N-methyl-2-pyrrolidone was added to the mixture, the anode current collector 52A made of a copper foil being 15 Aim thick was uniformly coated with the resultant, which was dried to form the anode active material layer 52B being 70 μm thick.

As Comparative examples 7-1,7-2, 8-1, and 8-2 relative to Examples 7-1,7-2, 8-1, and 8-2, secondary batteries were fabricated as in Examples 7-1,7-2, 8-1, and 8-2, except that a mixed solvent of 4-fluoro-1,3-dioxolan-2-one, the cyclic ester derivative and dimethyl carbonate at a volume ratio of 50:50 was used, or a mixed solvent of ethylene carbonate and CF₃CH₂OCOOCH₃, the chain compound at a volume ratio of 50:50 was used.

For the obtained secondary batteries of Examples 7-1,7-2, 8-1, and 8-2 and Comparative examples 7-1,7-2, 8-1, and 8-2, the discharge capacity retention ratio at the 50th cycle was measured as in Examples 1-1 to 1-7. The results are shown in Tables 4 and 5.

TABLE 4

| | | | Discharge |
|---|---|---|---|
| | | | capacity |
| | Anode active | | retention |
| | material | Solvent | ratio (%) |
| Example 7-1 | Sn | FEC + CF₃CH₂OCOOCH₃ | 74.0 |
| Example 7-2 | | FEC + CF₃CH₂OCOOCH₂CF₃ | 76.0 |
| Comparative | Sn | FEC + dimethyl carbonate | 62.0 |
| example 7-1 | | | |
| Comparative | | EC + CF₃CH₂OCOOCH₃ | 50.5 |
| example 7-2 | | | |

FEC: 4-fluoro-1,3-dioxolan-2-one
EC: ethylene carbonate

TABLE 5

| | | | Discharge |
|---|---|---|---|
| | Anode | | capacity |
| | active | | retention |
| | material | Solvent | ratio (%) |
| Example 8-1 | Sn—Co | FEC + CF₃CH₂OCOOCH₃ | 81.0 |
| | alloy | | |
| Example 8-2 | | FEC + CF₃CH₂OCOOCH₂CF₃ | 82.2 |
| Comparative | Sn—Co | FEC + dimethyl carbonate | 65.5 |
| example 8-1 | alloy | | |
| Comparative | | EC + CF₃CH₂OCOOCH₃ | 52.2 |
| example 8-2 | | | |

FEC: 4-fluoro-1,3-dioxolan-2-one
EC: ethylene carbonate

As evidenced by Tables 4 and 5, the results similar to of Examples 1-1 to 1-7 were obtained. That is, it was found that when the mixed solvent of a cyclic ester derivative having halogen atom and a chain compound having halogen atom was used, cycle characteristics could be improved in the case that the anode material capable of inserting and extracting an electrode reactant and containing metal elements or metalloid elements as an element was used.

### Examples 9-1,9-2, 10-1, 10-2, 11-1, 11-2, 12-1, 12-2, 13-1, 13-2, 14-1, 14-2, 15-1, 15-2, 16-1, and 16-2

As Examples 9-1,9-2, 13-1, and 13-2, secondary batteries were fabricated as in Examples 7-1 and 8-1, except that γ-butyrolactone as the solvent was further added, and the content of 4-fluoro-1,3-dioxolan-2-one and CF₃CH₂OCOOCH₃ in the solvent was changed. Then, 4-fluoro-1,3-dioxolan-2-one:CF₃CH₂OCOOCH₃:γ-butyrolactone (volume ratio) was respectively 30:30:40 or 20:20:60. That is, the content of 4-fluoro-1,3-dioxolan-2-one and CF₃CH₂OCOOCH₃ was respectively 60 volume % or 40 volume %.

As Examples 10-1, 10-2, 14-1, and 14-2, secondary batteries were fabricated as in Examples 7-1 and 8-1, except that propylene carbonate as the solvent was further added, and the content of 4-fluoro-1,3-dioxolan-2-one and CF₃CH₂OCOOCH₃ in the solvent was changed. Then, 4-fluoro-1,3-dioxolan-2-one:CF₃CH₂OCOOCH₃:propylene carbonate (volume ratio) was respectively 30:30:40 or 20:20:60. That is, the content of 4-fluoro-1,3-dioxolan-2-one and CF₃CH₂OCOOCH₃ was respectively 60 volume %, or 40 volume %.

As Examples 11-1, 11-2, 15-1, and 15-2, secondary batteries were fabricated as in Examples 7-1 and 8-1, except that dimethyl carbonate as the solvent was further added, and the content of 4-fluoro-1,3-dioxolan-2-one and CF₃CH₂OCOOCH₃ in the solvent was changed. Then, 4-fluoro-1,3-dioxolan-2-one:CF₃CH₂OCOOCH₃:dimethyl carbonate (volume ratio) was respectively 30:30:40 or 20:20:60. That is, the content of 4-fluoro-1,3-dioxolan-2-one and CF₃CH₂OCOOCH₃ was respectively 60 volume % or 40 volume %.

As Examples 12-1, 12-2, 16-1, and 16-2, secondary batteries were fabricated as in Examples 7-2 and 8-2, except that γ-butyrolactone or propylene carbonate as the solvent was further added, and the content of 4-fluoro-1,3-dioxolan-2-one and CF₃CH₂OCOOCH₂CF₃ in the solvent was 60 volume %. Then, 4-fluoro-1,3-dioxolan-2-one:CF₃CH₂OCOOCH₂CF₃:γ-butyrolactone (volume ratio) and 4-fluoro-1,3-dioxolan-2-one:CF₃CH₂OCOOCH₂CF₃:propylene carbonate (volume ratio) were 30:30:40.

For the obtained secondary batteries of Examples 9-1,9-2, 10-1, 10-2, 11-1, 11-2, 12-1, 12-2, 13-1, 13-2, 14-1, 14-2, 15-1, 15-2, 16-1, and 16-2, the capacity retention ratio at the 50th cycle was obtained as in Examples 1-1 to 1-7. The results are shown in Tables 6 and 7.

TABLE 6

| | | | Discharge |
|---|---|---|---|
| | | | capacity |
| | Anode active | | retention ratio |
| | material | Solvent | (%) |
| Example 7-1 | Sn | FEC (50) + CF₃CH₂OCOOCH₃ (50) | 74.0 |
| Example 9-1 | | FEC (30) + CF₃CH₂OCOOCH₃ (30) + GBL (40) | 75.0 |
| Example 9-2 | | FEC (20) + CF₃CH₂OCOOCH₃ (20) + GBL (60) | 75.2 |
| Example 10-1 | | FEC (30) + CF₃CH₂OCOOCH₃ (30) + PC (40) | 76.5 |
| Example 10-2 | | FEC (20) + CF₃CH₂OCOOCH₃ (20) + PC (60) | 76.2 |
| Example 11-1 | | FEC (30) + CF₃CH₂OCOOCH₃ (30) + DMC (40) | 76.0 |
| Example 11-2 | | FEC (20) + CF₃CH₂OCOOCH₃ (20) + DMC (60) | 75.0 |
| Example 7-2 | | FEC (50) + CF₃CH₂OCOOCH₂CF₃ (50) | 76.0 |
| Example 12-1 | | FEC (30) + CF₃CH₂OCOOCH₂CF₃ (30) + GBL (40) | 77.2 |
| Example 12-2 | | FEC (30) + CF₃CH₂OCOOCH₂CF₃ (30) + PC (40) | 78.0 |

FEC: 4-fluoro-1,3-dioxolan-2-one
PC: propylene carbonate
DMC: dimethyl carbonate
GBL: γ-butyrolactone

TABLE 7

| | | | Discharge |
|---|---|---|---|
| | | | capacity |
| | Anode active | | retention ratio |
| | material | Solvent | (%) |
| Example 8-1 | Sn—Co alloy | FEC (50) + CF₃CH₂OCOOCH₃ (50) | 81.0 |
| Example 13-1 | | FEC (30) + CF₃CH₂OCOOCH₃ (30) + GBL (40) | 82.5 |
| Example 13-2 | | FEC (20) + CF₃CH₂OCOOCH₃ (20) + GBL (60) | 81.5 |
| Example 14-1 | | FEC (30) + CF₃CH₂OCOOCH₃ (30) + PC (40) | 84.0 |
| Example 14-2 | | FEC (20) + CF₃CH₂OCOOCH₃ (20) + PC (60) | 83.0 |
| Example 15-1 | | FEC (30) + CF₃CH₂OCOOCH₃ (30) + DMC (40) | 82.6 |
| Example 15-2 | | FEC (20) + CF₃CH₂OCOOCH₃ (20) + DMC (60) | 82.0 |
| Example 8-2 | | FEC (50) + CF₃CH₂OCOOCH₂CF₃ (50) | 82.2 |
| Example 16-1 | | FEC (30) + CF₃CH₂OCOOCH₂CF₃ (30) + GBL (40) | 82.9 |
| Example 16-2 | | FEC (30) + CF₃CH₂OCOOCH₂CF₃ (30) + PC (40) | 84.5 |

FEC: 4-fluoro-1,3-dioxolan-2-one
PC: propylene carbonate
DMC: dimethyl carbonate
GBL: γ-butyrolactone

As evidenced by Tables 6 and 7, the results similar to of Examples 3-1 to 3-4,4-1 to 4-4,5-1, 5-2,6-1, and 6-2 were obtained. That is, it was found that the content of the cyclic ester derivative having halogen atom and the chain compound having halogen atom in the solvent was preferably 40 volume % or more.

The present invention has been described with reference to the embodiments and the examples. However, the present invention is not limited to the embodiments and the examples, and various modifications may be made. For example, in the foregoing embodiments and examples, descriptions have been given with reference to the coin-type secondary battery and the secondary battery having a winding structure. However, the present invention can be similarly applied to a square-type secondary battery, a sheet-type secondary battery, a card-type secondary battery, or a secondary battery having a structure in which the cathode and the anode are layered several times. Further, the present invention can be applied not only to the secondary batteries but also to other batteries such as the primary batteries.

Further, in the foregoing embodiments and examples, descriptions have been given of the case using lithium as an electrode reactant. However, the present invention can be applied to the case using other element of Group 1 in the long period periodic table such as sodium (Na) and potassium (K), an element of Group 2 in the long period periodic table such as magnesium and calcium (Ca), other light metal such as aluminum, or an alloy of lithium or the foregoing elements as well, and similar effects can be thereby obtained. Then, for the anode active material, the anode material as described in the foregoing embodiments can be similarly used.

It should be understood by those skilled in the art that various modifications, combinations, sub-combinations and alternations may occur depending on design requirements and other factors insofar as they are within the scope of the appended claims or the equivalents thereof.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. a cathode;
an anode; and
an electrolyte,
wherein the anode contains an anode material capable of inserting and extracting an electrode reactant and containing at least one of a metal element and a metalloid element, and wherein
the electrolyte contains a cyclic ester derivative having a halogen atom and at least one of a chain compound expressed in Chemical formula 1 to Chemical formula 8 as follows: 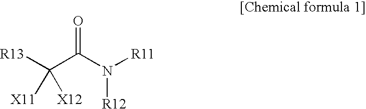
wherein R11 and R12 represent a hydrogen group, an alkyl group with carbon number of 1 to 15 or a group obtained by substituting at least part of hydrogen thereof with halogen, an alkoxyl group with carbon number of 2 to 15 or a group obtained by substituting at least part of hydrogen thereof with halogen, an aryl group with carbon number of 6 to 20 or a group obtained by substituting at least part of hydrogen thereof with halogen, a group obtained by substituting part of hydrogen of an alkyl group with carbon number of 7 to 20 with an aryl group or a group obtained by substituting at least part of hydrogen thereof with halogen, or an acyl group with carbon number of 1 to 15; R13 represents a hydrogen group, a halogen group, an alkyl group with carbon number of 1 to 20 or a group obtained by substituting at least part of hydrogen thereof with a substituent, an alkoxyl group with carbon number of 1 to 20 or a group obtained by substituting at least part of hydrogen thereof with a substituent, a group obtained by substituting at least part of hydrogen of an aryl group with carbon number of 7 to 20 with an alkoxyl group or a group obtained by substituting at least part of hydrogen thereof with other substituent, an acyl group with carbon number of 1 to 20 or a group obtained by substituting at least part of hydrogen thereof with a substituent, an aryl group with carbon number of 6 to 20 or a group obtained by substituting at least part of hydrogen thereof with halogen, or a heterocyclil group with carbon number of 4 to 20 or a group obtained by substituting at least part of hydrogen thereof with halogen; and X11 and X12 represent a halogen group or a perfluoro alkyl group with carbon number of 1 to 10; 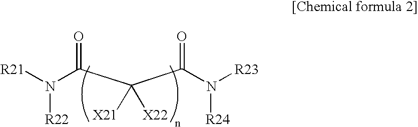
wherein R21, R22, R23, and R24 represent a hydrogen group, an alkyl group with carbon number of 1 to 15 or a group obtained by substituting at least part of hydrogen thereof with halogen, an alkoxyl group with carbon number of 2 to 15 or a group obtained by substituting at least part of hydrogen thereof with halogen, an aryl group with carbon number of 6 to 20 or a group obtained by substituting at least part of hydrogen thereof with halogen, a group obtained by substituting part of hydrogen of an alkyl group with carbon number of 7 to 20 with an aryl group or a group obtained by substituting at least part of hydrogen thereof with halogen, or an acyl group with carbon number of 1 to 15; X21 and X22 represent a halogen group or a perfluoro alkyl group with carbon number of 1 to 10; and n represents an integer number from 1 to 4; 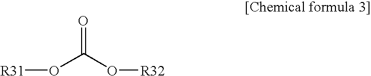
wherein R31 and R32 represent an alkyl group with carbon number of 1 to 5 or a group obtained by substituting at least part of hydrogen thereof with halogen, and at least one of R31 and R32 is a group having halogen; 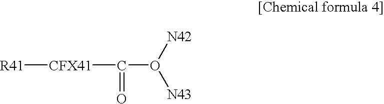
wherein R41 represents a hydrogen group, a fluorine group, a chlorine group, a bromine group, or an alkyl group with carbon number of 1 to 3 or a group obtained by substituting at least part of hydrogen thereof with halogen; X41 represents a hydrogen group, a fluorine group, a chlorine group, or a bromine group; and R42 and R43 represent a methyl group or an ethyl group; 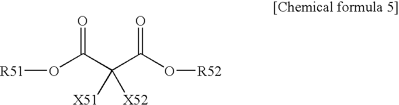
wherein R51 and R52 represent an alkyl group with carbon number of 1 to 3, an aryl group, or a group obtained by substituting at least part of hydrogen thereof with halogen; and X51 and X52 represent a hydrogen group, a halogen group, or a trifluoromethyl group, and at least one of X51 and X52 is a group having halogen; 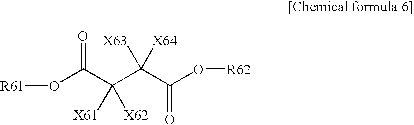
wherein R61 and R62 represent an alkyl group with carbon number of 1 to 3, an aryl group, or a group obtained by substituting at least part of hydrogen thereof with halogen; and X61, X62, X63, and X64 represent a hydrogen group, a halogen group, or a trifluoromethyl group, and at least one of X61 and X62 and at least one of X63 and X64 are a group having halogen; 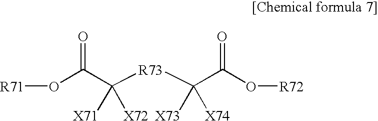
wherein R71 and R72 represent an alkyl group with carbon number of 1 to 3, an aryl group, or a group obtained by substituting at least part of hydrogen thereof with halogen; R73 represents oxygen, sulfur, SO, SO₂, N—X (where X represents a monovalent substituent), P-Z (where Z represents a monovalent substituent), a group having alicycle, aromatic ring or heterocycle, an alkylene group with carbon number of 1 to 4 or a group obtained by substituting at least part of hydrogen thereof with halogen or a trifluoromethyl group, or a group with carbon number of 1 to 4 having oxygen, sulfur, SO, SO₂, N—X (where X represents a monovalent substituent), or P-Z (where Z represents a monovalent substituent) between carbon atoms or a group obtained by substituting at least part of hydrogen thereof with halogen or a trifluoromethyl group; and X71, X72, X73, and X74 represent a hydrogen group, a halogen group, or a trifluoromethyl group, and at least one of X71 and X72 and at least one of X73 and X74 are a group having halogen; 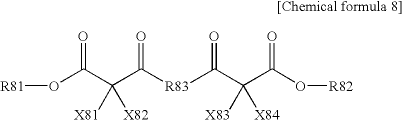
wherein R81 and R82 represent an alkyl group with carbon number of 1 to 3, an aryl group, or a group obtained by substituting at least part of hydrogen thereof with halogen; R83 represents oxygen, sulfur, SO, SO₂, N—X where X represents a monovalent substituent, P-Z where Z represents a monovalent substituent, a group having alicycle, aromatic ring, or heterocycle, an alkylene group with carbon number of 1 to 4 or a group obtained by substituting at least part of hydrogen thereof with halogen or a trifluoromethyl group, or a group with carbon number of 1 to 4 having oxygen, sulfur, SO, SO₂, N—X where X represents a monovalent substituent, or P-Z where Z represents a monovalent substituent between carbon atoms or a group obtained by substituting at least part of hydrogen thereof with halogen or a trifluoromethyl group; and X81, X82, X83, and X84 represent a hydrogen group, a halogen group, or a trifluoromethyl group, and at least one of X81 and X82 and at least one of X83 and X84 are a group having halogen; and

2. A battery according to claim 1, wherein as the cyclic ester derivative, at least one from the group consisting of cyclic carboxylate ester derivatives and a cyclic ester carbonate derivative expressed in Chemical formula 9 as follows is contained: 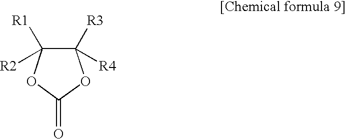
wherein R1, R2, R3, and R4 represent a hydrogen group, a fluorine group, a chlorine group, a bromine group, a methyl group, an ethyl group, or a group obtained by substituting part of hydrogen of a methyl group or an ethyl group with a fluorine group, a chlorine group, or a bromine group, and at least one thereof is a group having halogen.

3. A battery according to claim 1, wherein a content of the cyclic ester derivative and the chain compound is about 40 volume % or more with respect to a total volume.

4. A battery according to claim 1, wherein the anode contains a material containing at least one of silicon and tin.
